(19) United States
(12) Patent Application Publication
(10) Pub. No.: US 2026/0209020 A1
(43) Pub. Date: Jul. 23, 2026

(54) A MULTI-PRODUCT FILLER DEVICE

(71) Applicant: Anheuser-Busch InBev S.A., Brussels (BE)

(72) Inventors: Glenn FERREIRA, Leuven (BE); Philippe Jean Marie DUPERRAY, Châteauroux (FR)

(21) Appl. No.: 19/142,426

(22) PCT Filed: Dec. 12, 2023
(86) PCT No.: PCT/EP2023/085433

§ 371 Date: Jun. 23, 2025

(30) Foreign Application Priority Data
Dec. 21, 2022 (EP) 22215700.0

(51) Int. Cl. B67C 3/02; B67C 3/28

(52) U.S. Cl. CPC B67C 3/023; B67C 3/282

(57) ABSTRACT

A multi-product filler device (2) comprising: a first product inlet (4) for supplying a product to the device; a first reservoir (6) configured to contain a volume of product; a first supply conduit (10) connected to the first product inlet (4) and the first reservoir (6) and configured to supply product to the first reservoir; a first filler valve (12) configured to dispense product into a first container; a first filler conduit (14) connected to the first reservoir (6) and the first filler valve (12) for delivering product from the first reservoir (6) to the first filler valve (12); a second product inlet (16) for supplying a product to the device; a second reservoir (18) configured to contain a volume of product; a second supply conduit (22) connected to the second product inlet (16) and the second reservoir (18) and configured to supply product to the second reservoir; a second filler valve (28) configured to dispense product into a second container a second fluid filler conduit (26) connected to the second reservoir (18) and the second filler valve (28) for delivering product from the second reservoir to the second filler valve.

The present invention relates to a multi-product filler device and a method of operating the same.

It is known in the art to use devices, on filling lines, to dispense a given product into a particular container. Examples of such products include liquid beverages. Conventional filling systems fill one product at a time i.e. the device may have a number of dispensing means but each of the dispensing means dispenses the same product for the duration of a production run. Typically, a single reservoir of product is used and is in fluid communication with each of the dispensing means (filler valves). An important challenge associated with these conventional systems concerns the production of multi-product multipacks (variety packs). For the purpose of this document, a multi-product multipack refers to a collation of filled containers, the containers containing different products. One example of a multi-product multipack is a collation of differently flavoured beverages of the same product family. Another example of a multi-product multipack is a collation of completely different products. This is in contrast to a single product multipack, being a packaged collation of filled containers, each contain the same product (e.g. a pack of eight of the same bottled or canned beverage).

Owing to the fact that conventional systems only fill one type of product at a time, the production of multi-product multipacks includes either repacking operations or intermediate buffering (WIP—‘work in progress’) operations, once stock of all the different products making up the desired multi-product multipack are available. In intermediate storage (WIP) operations, filled containers, which contain a single variety of product, are transported away from the filling device and temporarily stored in an intermediate work in progress (WIP) product buffering facility, before being collated with filled containers containing a different product and packaged into the desired multi-product multipacks. With repackaging operations, containers filled with a single product are packed into intermediate secondary packaging and transported, stored and handled locally or to a remote repackaging operation and are then subsequently unpacked and collated with filled containers containing a different product and packaged into the desired multi-product multipacks. Associated disadvantages include handling filled containers multiple times; the incurrence of additional storage, personnel (at all levels and functions), equipment, utility consumption, factory real estate, intermediate packaging material wastage, product losses, operational inefficiencies, transportation, warehousing and logistic operations; all collectively resulting in significant time delays, stock management challenges and higher manufacturing costs.

One specific example of intermediate storage operations is the use of an automated storage and retrieval system (ASRS). The ASRS may be used to locally store, and subsequently locate and ‘pick’, containers filled with different product varieties (for collation in secondary packaging). However, ASRS's are costly, challenging to clean and maintain, occupy key factory real estate close or embedded in manufacturing halls and ultimately have limited capacity. Further disadvantages of ASRS's include the fact that leakage of a single container can temporarily spoil large swathes of an ASRS (i.e. requiring the system be paused whilst cleaning occurs). In the case of an ASRS (WIP) handling decks of single loose product (a large area mat top conveyor designed to buffer a layer of base supported product, i.e. not packaged into any intermediate ASRS bin system) the ASRS operates more as a batch process (i.e. does not operate continuously), and/or imposes operational constraints on how many and which maximum quantities of bottles or cans filled with the different products may be buffered before secondary packaging into the desired multi-product multipacks.

There exists a need to overcome one or more of the disadvantages associated with existing solutions, whether mentioned in this document or otherwise.

According to a first aspect of the invention there is provided a multi-product filler device comprising:
a first product inlet for supplying a product to the device;
a first reservoir configured to contain a volume of product;
a first supply conduit connected to the first product inlet and the first reservoir and configured to supply product to the first reservoir;
a first filler valve configured to dispense product into a first container;
a first filler conduit connected to the first reservoir and the first filler valve for delivering product from the first reservoir to the first filler valve;
a second product inlet for supplying a product to the device;
a second reservoir configured to contain a volume of product;
a second supply conduit connected to the second product inlet and the second reservoir and configured to supply product to the second reservoir;
a second filler valve configured to dispense product into a second container
a second fluid filler conduit connected to the second reservoir and the second filler valve for delivering product from the second reservoir to the second filler valve.

Multi-product filler devices according to the disclosure may overcome the many disadvantages of the prior art. Importantly, they eliminate the need for storage operations such as ASRS's and thus greatly reduce the footprint, complexity and cost of producing multi-product multipacks. They may be suitable for continuously running with multiple products, thus increasing capacity and, advantageously, seamlessly change between different product lines or product combinations without requiring change-parts—greatly reducing the time and cost of multi-run operations. Finally, multi-product multipacks can be packed immediately, all while maintaining filler precision. In summary, therefore, the multi-product filler device increases capacity, efficiency, reliability and flexibility, while eliminating the need for ASRS's and thus reducing operations footprint, complexity and cost.

The multi-product filler device may be described as a rotary primary container filling machine having multiple, reconfigurable, mix-proof, independent fluid handling, storing and dispensing channels which may be configured for the equal production of filled primary containers per production run, and in such a way that the full or very nearly full installed filling device production capacity is always realised, regardless of the number products being produced (up to the maximum number of different products the filler device is designed for) and that though the array of products filled may not necessarily be discharged in consistently repeating and/or sequential order, are always produced in equal quantity per fluid stream, per revolution of the rotary filler device carousel.

The multi-product filler device may be referred to as a multi-liquid filler. The multi-product filler device may be referred to as a multi-product dispensing device, or system. The multi-product filler device may comprise multiple filler valves. The multi-product filler device may comprise at least one filler valve for the maximum number of different products which the primary container filling device is designed and constructed to fill. The multi-product filler device may comprise multiple filler valves for each of the maximum number of different products which the primary container filling device is designed and constructed to fill The multi-product filler device may form part of a production line (e.g. a filling and packaging line). The multi-product filler device may form part of a beverage filling line. The multi-product filler device may pre-treat (e.g. rinse), fill and seal primary containers. Further primary container pre-treatment may be a sub-system and include wet or dry rising, flushing, cleaning and/or sterilisation. The sealing of containers may be carried out by a container closing sub-system, which may apply a closure corresponding to the container in question (e.g. a can lid, bottle crown, screw top [ROPP or PCR], swing-top or ring pull closure). The multi-product filler device may receive a single (file) stream of empty primary containers. The multi-product filler device may output (e.g. discharge) a single (file) stream of filled containers. Discharged, filled containers may be further subjected to in-pack pasteurisation (if needed), inspection and coding, before being processed and packaged continuously via a secondary packer into the desired multi-product multipacks.

The first product inlet may supply a first product. The first filler valve may dispense the first product. The second product inlet may supply a second product. The second filler valve may dispense the second product. The first and second products may be different products. The first and second product inlets, and any further product inlets, may be described as simultaneously supplying respective products. The products may be supplied from a series of finished product tanks and/or in the form of a pre-filler base liquid with multi-stream final product inline blending performing late product differentiation immediately before the multi-product filler. The device may comprise two or more different product inlets. The device may typically comprise between 4 and 8 product inlets, but could be configured with more. The number of different liquids could be even or odd. The number of reservoirs may be equal to the number of different product inlets. The reservoirs may be described as ‘finished product reservoirs’ or ‘final product reservoirs’ in that the product stored in the reservoirs is in the same form as it will be dispensed into the primary containers (one liquid per container). For example, where the product is a beverage, the beverage is preferably in a consumption-ready form (i.e. not a base liquid and/or flavour syrup). The multi-product filler device preferably comprises at least four reservoirs, the at least four reservoirs comprising the first and second reservoirs. The multi-product filler device may comprise up to, or in excess of, 8 reservoirs.

Each filler valve is preferably only connected to one (i.e. a single) filler conduit. Put another way, each filler valve preferably has a corresponding single, individual filler conduit connected to it. The filler conduits can be placed in selective fluid communication with one of a plurality of different reservoirs. Some filler conduits may only be connected or connectable to a single reservoir, others may be selectively connectable to one of a plurality of different reservoirs (e.g. by way of mix-proof valves). It will be appreciated that, by virtue of each filler valve being connected to a given filler conduit, where the filler conduit is described as being connected or connectable to one or more reservoirs, the filler valve is also connected or connectable to one or more reservoirs (albeit indirectly). Advantageously, each filler valve being connected to a single filler conduit provides for a more efficient fluid circuit than if, for example, each filler valve had a separate filler conduit for each reservoir connection (where appropriate).

The container into which product is dispensed is preferably a beverage container such as a can or a bottle. The container may be an aluminium can or a glass bottle, to name two examples. The container may be a PET, or aluminium, bottle. The container may be, but is not limited to, a rigid or semi-rigid container.

In preferred embodiments the products are carbonated or non-carbonated liquids, such as beverages (e.g. juices, flavoured or non-flavoured dairy or plant based drinks, soft drinks, flavoured or scented waters, teas, seltzers, energy drinks, ready to drink (RTD) beverages, beer, flavoured beer or near beer beverages or beer based beverages). As described elsewhere, the multi-product filler device is particularly advantageous where at least two flavour variants (e.g. at least two different flavours of soft drink) are to be included in a multi-product multipack. The beverages are preferably ‘finished beverages’ (i.e. the beverages held in the reservoirs, and dispensed, are in the same form in which they would be consumed). This is in contrast to, for example, non-finished products (such as a base liquid stored in a reservoir and subsequently mixed with a flavoured syrup). Finished beverages may otherwise be described as prepared, ready to drink, beverages.

The multi-product filler device provides a number of advantages over existing solutions. The device is expandable in nature in that more product inlets, reservoirs, supply conduits, filler valves and filler conduits can be added to a device so that a greater number of products can be dispensed continuously (and into a greater number of containers), i.e. the production range and/or rate may be increased through the construction of larger devices comprising more liquid inlets and/or more filling valves. The multi-product filler device is particularly advantageous when filling containers to be incorporated in a multi-product multipack comprising containers of different products (e.g. different flavour variants). Up to, and in excess of, eight different products may be dispensed into respective containers (i.e. a first product be dispensed into a first container, a second product be dispensed into a second container etc.), continuously, using the multi-product filler device. The multipacks produced may have an equal distribution of different flavours (e.g. a multipack of 8 cans may have 4 cans filled with a first flavour variant and 4 cans filled with a second flavour). Alternatively, the multipacks may have an unequal distribution of different flavours. One example of an unequal distribution of flavours is a sample pack in which the multipack contains, for example, 5 cans filled with a first flavour variant and an additional 3 cans each filled with a different respective flavour variant. As mentioned above, the multi-product filler device provides this capability in a fully adjustable manner, facilitating a high level of production flexibility. The multi-product filler device may also be utilized in a conventional mode where all liquid inlets, reservoirs and valves process the same product for packaging into mono-flavoured packs.

The multi-product filler device may have a capacity (primary containers filled per hour) from small to large and in practical terms may typically be realized in output from around 20,000 up to around 140,000 filled containers per hour, though yet smaller or large executions may also be possible. A multi-liquid filler device with a given number of liquid inlets may process production (product filling) assignments of between one liquid and quantities of different liquids between two and the number of different liquids equalling the number of liquid inlets. For example, an eight liquid multi-product filling device may process a filling assignment of between one and eight liquids (i.e. could be filling one liquid, two liquids, three liquids, four, five, six, seven, eight liquids) and always at or near full filler design capacity (or at an acceptable filler capacity vs complexity trade-off compatible with the overall production line capacity).

Further advantageously, the multi-product filler device may mitigate the need for repackaging and/or inline buffering operations (and therefore has a comparatively low footprint of space needs). Repackaging involves unpacking and then repacking filled containers which have previously been produced via a filling device which can only fill a single product at a time (i.e. a single product per production run (manufacturing assignment)) in order to obtain a multi-product multipack. With inline buffering the various containers are filled one at a time, separately and, once a sufficient level of filled containers has been reached, the various filled containers are then discharged in controlled streams into secondary packaging to assemble the desired multi-packs. Both methods have associated disadvantages (e.g. high cost, high waste levels, large footprint, lack of flexibility), and are generally inefficient. The multi-product filler device can therefore eliminate the need for buffering work in progress (WIP) and thus avoid the need for an automated storage and retrieval system (ASRS) and avoid the associated cost/space claim/maintenance/cleaning and servicing disadvantages associated with ASRS's. Instead, the multi-product filler device effectively expands the range (number of different liquids) and provides in-process filling capability for simultaneously, and continuously, filling containers with different products as required for the multipack in question. The multi-product filler device also avoids costly rework, intermediate material wastage, and removes the need for significant packaging real estate at a production line.

A further advantage provided by the multi-filler device is that, although as mentioned above it gives rise to the possibility of continuously filling containers with different products, the multi-product filler device can still be used to produce single variety multipacks (e.g. multipacks containing multiple containers but with each container having the same product). The multi-product filler device can therefore operate as a conventional filler (e.g. where a single variety of product is dispensed into various containers) but can also produce multi-variety multipacks (e.g. where the single device can continuously fill containers with different respective products) in a continuous manner. The multi-product filler device is therefore very flexible, even at a significant scaled output, and maintains a high degree of productivity at or near maximum system capacity regardless of the number of products being filled (or depending on the manner of multi-liquid filler device execution, at an acceptable filler capacity vs complexity trade-off compatible with the overall production line capacity).

A further advantage of the multi-product filler device is that it can be retrofitted to existing packaging line systems. This is particularly desirable for the reason that with other associated enablers, existing infeed (e.g. container supply) and outfeed (e.g. container output) systems can be used, among other surrounding systems.

The multi-product filler device is able to simultaneously fill a series supply of primary product containers with different products, each (one product per container). This advantageously provides the capability to effectively and simultaneously supply a continuous flow of containers, filled with the different products each, for direct sequencing and collation into multi-product multipacks, without delay and also as a continuous operation until the desired quantity of a given execution of multi-pack is produced.

The first reservoir may be connected to the second product inlet. The first reservoir or one or more sectors of the first reservoir, connected with the first product inlet, via the first supply conduit and distribution to each sector thereof, may additionally be in fluid communication with the second product inlet via one or more separate supply conduits such that the said one or more sectors of the first reservoir can be individually and selectively placed in fluid communication with either the first product inlet or the second product inlet, for the duration of a given production run.

The first filler valve may additionally be connected to the second reservoir. The first filling conduit in fluid communication with the first reservoir and serving the first filler valve, may additionally be in fluid communication with the second reservoir such that the first filler valve can be selectively placed in fluid communication, via the filling conduit, with either the first reservoir or the second reservoir.

In some embodiments the first filler conduit may be additionally connected to the second reservoir (e.g. such that the first filler valve can be selectively placed in fluid communication with either of the first reservoir or the second reservoir). Described another way, a single filler conduit may be associated with each filler valve and more than one reservoir. Alternatively, a respective filler conduit may be connected between each of the first and second reservoirs and the first filler valve (e.g. such that the first filler valve can be selectively placed in fluid communication with either of the first reservoir or the second reservoir).

Advantageously, the multi-product filler device can selectively be configured, for a product filling assignment, to dispense a different product through a given filler valve than the default configuration by: (1) placing a respective reservoir, to which the filler valve is connected, in fluid communication with a different product inlet than the default product inlet the reservoir and whilst the filler valve remains connected to the (single) given reservoir; and/or (2) selectively placing the filler valve in fluid communication with an alternate product reservoir and where the particular reservoir is connected to a given product inlet). Advantageously the routing of a product to a filling valve, for the duration of a given production assignment (production run), may be via a combination of configuration methods 1 and 2 described above.

The first reservoir may be further connected to the second supply conduit, by means of a mix-proof valve, for supplying product from the second product inlet to the first reservoir; and/or the first filler conduit may be connected to the first and second reservoirs, and the first filler conduit may comprise a mix-proof valve associated with each of the first and second reservoirs.

The first supply conduit may be a first supply conduit network, comprising a conduit for fluidically connecting the first reservoir to the second supply conduit, for example by way of a mix-proof valve.

A mix-proof valve being associated with each of the first and second inlets may otherwise be described as a mix-proof valve being provided in-line between the reservoir and the product inlet. Similarly, a mix-proof valve being associated with each of the first and second reservoirs is intended to mean that a mix-proof valve is provided in-line between the first and second reservoirs and the first filler conduit. Mix-proof valve is intended to mean a valve which has enhanced leak-proof capabilities in the event of valve failure (e.g. a valve in which, if a leak occurs, the leak is to atmosphere). The mix-proof valve may be referred to as a multi-seat or multi-seal valve (e.g. a double seat valve or a double seal valve). The mix-proof valve advantageously reduces the risk that, in the event of valve failure, multiple products and/or media (e.g. water, gas, detergent, utility heating or cooling fluids) would mix with one another undesirably in a given supply conduit or filler conduit (e.g. reduces the risk of contamination occurring). An example of a mix-proof valve is a double block and bleed, or double block and vent, valve and provides assured separation of different liquids. A set of standard valves may otherwise be used in place of a mix-proof valve, achieving a block, block and with a vent to atmosphere in between and thus achieving the same functional requirement as a mix-proof valve. Standard single seat valves may be used for the fluid routing but at the risk of uncontrolled and undesirable fluid mixing upon a compromised valve sealing.

The multi-product filler device may be a rotary multi-product filler device and the reservoirs may be annular bowls (vessels) and/or sectors of annular bowls (vessels) thereof. The annular bowls may be stacked on top of one another in a vertical arrangement. The annular bowls may be arranged concentrically with one another. The annular bowls may be arranged in the same plane or out of the plane (e.g. at least partially vertically offset from one another). The annular bowls may be provided in a staggered arrangement. The annular bowls may be of any cross section (e.g. circular, oval, oblong, obround, polygonal, squircle). The annular bowls may be circular, cylindrical or polygon (faceted) in plan view shape about a central axis of rotation of the rotary filling device. The rotating portion of a rotary multi-product filler device may otherwise be referred to as a carousel. As suggested by the name, the rotary multi-product dispensing device may rotate about an axis of rotation. Advantageously, the rotary multi-product filler device can receive a single-file supply of containers from an infeed supply and these containers be filled sequentially as the multi-product filler device rotates. Rotary multi-product fillers may comprise a quantity of filling valves at least as much as the number of product inlets (e.g. 8) and up to 176 filler valves or more. In the default state (i.e. without pre-reservoir and/or post reservoir alternate fluid connection/s (routing)) the number of filling valves may normally be a numeric multiple of the number of product inlets. The greater the number of filling valves, the greater the dimensions and capacity of the multi-liquid filling device. The multi-liquid filling device primary container pre-treatment and post filling primary container closing (sealing) devices being scaled up with an equivalent number of primary container processing units (heads) that the capacity of these respective units always matches that of the multi-liquid filling device. The annular bowls being arranged in the same plane (i.e. not vertically offset from one another) is advantageous in avoiding significant hydrostatic variations of the products held in the various reservoirs. This, in turn, makes the control of the dispensing more straightforward (e.g. the flowrates of the different products are more uniform). The supply of different products, one product to each reservoir, is routed into the rotary carousel of the multi-product filling device via a mix-proof multi-channel hub at the axis of rotation of the rotary filling device. Each product and utility media is maintained separate in an assured fashion via double seal and vent mix-proof fluid or media containment and channelling arrangements, effectively transitioning from the stationary to the rotary environment of the equipment.

The reservoirs being annular bowls, or sectors thereof, is particularly well suited to the rotary multi-product filler device because the annular bowls, or sectors thereof, can serve a number of different filler valves distributed around the rotary multi-product filler device (e.g. around an axis of rotation thereof).

The multi-product filler device may comprise (for example) eight product inlets, including the first and second product inlets, for supplying products to the device. The eight product inlets may otherwise be referred to as eight product sources. Advantageously, the multi-product filler device comprising eight product inlets means that the multi-product filler device can be used to dispense between one and eight different products (e.g. one single flavour or up to eight different flavours of a beverage while always maintaining full or near full multi-liquid filler capacity) as part of a continuous filling process. As such, the single multi-product filler device can (continuously) fill the various containers which form an e.g. eight product multipack and that pack may comprise eight primary containers of the same product or eight primary containers of different products or any set of a fewer number of different products making up an equally proportioned or un-equally proportioned set eight primary product containers in assembly of the eight count multi-product multipack.

The multi-product filler device may comprise (for example) eight reservoirs, including the first and second reservoirs. Reservoirs is intended to mean a volume in which a product can be held. In the case of annular bowls, where at least some of the bowls may be split or segmented into sectors, each individual sector of the bowl may be a reservoir. Advantageously, the multi-product filler device comprising eight reservoirs means that there is a respective reservoir for each of up to eight different products. A respective product can therefore be stored in a respective reservoir, avoiding cross contamination of products and providing an effective buffer of products as part of the filling process. Likewise a sector of an annular bowl is a reservoir in its own right being totally isolated (mix-proof) and thus avoiding cross contamination of products while providing effective buffering of products as part of the filling process. Sectors of a reservoir can be used individually, in pairs or in sets as part of different product distributions and therefore filler valve product supplies for balanced dispensing into primary containers (e.g. cups, jars, bottles, cans). Balanced dispensing referring to the achievement of equal quantities of dispensed product (number of primary containers) per product stream, per revolution of the rotary filling device. The dispensed product not necessarily needing to be in repeating product or product flavour order or groups thereof, but needing to be of the same quantity per revolution of the filling device.

The device may be a multi-beverage filler device for use as part of a filling plant. As mentioned above, the products dispensed are preferably beverages. Advantageously, the multi-product filler device being a multi-beverage filler device means that a single device can be used to continuously produce filled containers which contain different beverages and which make up a multi-product multipack. A number of advantages are attributable to the multi-beverage filler device being used as part of a filling plant including, but not limited to, vastly improved efficiency, scalability and flexibility in comparison to existing systems in which only a single variety product is dispensed by a given filler device and produced through the overall packaging line, at a time.

The first supply conduit may be in fluid communication with two or more product inlets, up to being connected to all of the product inlets such that the first reservoir may be selectively placed in fluid communication with any of the two or more, up to all of the product inlets. Advantageously, by being able to selectively place the first reservoir in fluid communication with two or more, up to all of the product inlets, the first supply conduit may be used to supply the first reservoir with any one of a number of different products (e.g. where different products are supplied via the various product inlets). Where that reservoir is in fluid communication with a filler valve, the filler valve can therefore be used to dispense whichever of the products is present in the reservoir (into a container at each revolution of the multi-liquid filling device, for the duration of the filling run). This advantageously means that the multi-product filler device can be reconfigured between filling runs such that the filler valve dispenses different products at each filling run and for the duration of each run. For completeness, it is not anticipated that the multi-product filler device be adjusted mid-filling process, but that the device be temporarily deactivated, the relevant lines flushed, and the relevant connections adjusted (typically executed automatically by the filler control system and as directed via operator inputs and selections at the operator machine interface panel (HMI)) before a new filling process begins.

The device may further comprise:
a plurality of product inlets for supplying a product to the device, including the first and second product inlets;
a plurality of reservoirs, including the first and second reservoirs, configured to contain a volume of product (and with reservoirs optionally being sub-sectors of larger reservoirs (e.g. sectors of an annular bowl));
a plurality of supply conduits, including the first and second supply conduits, each supply conduit may be connected to at least one of the product inlets and a respective one of the reservoirs and configured to supply product to the respective reservoir; wherein
each reservoir of a subset of the reservoirs is connected to at least two (and optionally up to all) of the product inlets such that the respective reservoirs can be selectively placed in fluid communication with any of the two or more (up to all) of the product inlets.

The first reservoir may be a circumferential sector of a segmented annular bowl. The first reservoir being a circumferential sector of a segmented annular bowl is intended to mean that the first reservoir may be defined by at least part of a generally annular geometry. That is to say, rather than being a continuous annular shape, the first reservoir may be only part of an arcuate portion of an annular bowl. The annular bowl being segmented is intended to mean that the bowl is divided into at least two different sectors, the different sectors occupying extents of the overall circumference of the bowl. In preferred embodiments, only a subset of the annular bowls are segmented. Advantageously, the first reservoir being a circumferential sector of a segmented annular bowl means that the first segmented bowl (being a collection of sectors making a 360° whole annular bowl (reservoir)) may be used to dispense multiple different products (e.g. one product per reservoir). The reconfigurable functionality of the multi-product filler device can therefore be achieved whilst reducing the number of mix-proof valves used (in comparison to, for example, instances where the filler valves are connectable to a plurality of different reservoirs). The device may further comprise a plurality of supply conduits, including the first and second supply conduits, each supply conduit being connected to at least one of the product inlets and a respective one of the reservoirs and configured to supply product to the respective reservoir. Each of the supply conduits associated with a subset of the reservoirs may be connected to one, two or more (up to all) of the product inlets such that the respective reservoirs can be selectively placed in fluid communication with any of the one, two or more (up to all) product inlets.

A segmented bowl embodiment may provide slightly lower output than an embodiment where the filler valve can be connected to multiple different reservoirs. However, the incidence of true 100% filler utilization may be higher, while the occasion where lower capacity may incurred may be found to be commensurate with lower overall packaging line capacity for an associated packaging pattern (arrangement of primary containers in a packaging) and hence the lower filler capacity may still be deemed to be acceptable. The alignment of filler capacity vs packaging line capacity requirements may allow an individual skill in the art to avoid system complexity, as may be the case with managing the fluid connection of the reservoirs with the product inlets vs managing the filler valves with multiple reservoirs.

The device may comprise fourteen reservoirs including the first and second reservoirs, wherein:
five of the reservoirs are annular bowls;
nine of the reservoirs are sectors of segmented annular bowls, the nine sectors collectively forming three further annular bowls; and
the first reservoir is one of the sectors of a segmented annular bowl. This may be the case in the example of a multi-product filling device comprising 8 product inlets.

Advantageously, five of the reservoirs being annular bowls means that five of the bowls do not need to be segmented, to define multiple reservoirs, with the associated increased complexity of doing so. Described another way, for filler devices dispensing up to eight different products, it is possible to utilise five annular bowl reservoirs with only an additional three bowls effectively being segmented. For this 8 product inlet example, the 8 bowl with 3 of the 8 bowls having 3 sectors configuration, permits the system to operate at 100% capacity utilization regardless of whether 1, 2, 3, 4, 6, 8 different products are continuously processed. In this 8 bowl with 3 of the 8 bowls having 3 sectors configuration, the filler capacity would drop to 83% when running 5 or 7 different products, which may still be compatible with the overall filling line capacity demand for packaging patterns demanding that number of different products in a multipack (e.g. 1×5 or 1×7 single row of products e.g. suitable for placement in a refrigerator door). Accordingly, the complexity of the system can therefore be reduced whilst maintaining the functionality of being able to dispense up to eight different products at full multi-product filling device capacity. Additionally, in the 8 bowl with 3 of the 8 bowls having 3 sectors example, the capacity reduction when processing 5 or 7 different products, may be alleviated via placing a few of the filler valves in mix-proof fluid connection with filler reservoirs different from their default filler reservoir.

For this 8 product inlet example, the device may comprise:
eight product inlets for supplying a product to the device, including the first and second product inlets; wherein
each of the nine sector reservoirs may be connected to one, two or more (e.g. three, four, five, six or up to all) of the product inlets such that the associated reservoirs can be selectively placed in fluid communication with any of the one, two or more (up to all) of the product inlets.

As an example, a multi-product filler device may comprise eight reservoirs, including the first and second reservoirs, and the first filler conduit may be connected to one, two or more (e.g. three, four or five, up to all) of the reservoirs such that the first filler valve can be selectively placed in fluid communication with any of the respective reservoirs. Advantageously, being able to place the first filler valve in selective fluid communication with any of the one, two, or more (up to all) reservoirs means that the filler valve can be configured for a given production run, to dispense the product contained within any of the reservoirs. The multi-product filler device can therefore be used to selectively dispense different liquid products as required by the filling line for the duration of that production run. The multi-product filler device may for example, consist of eight reservoirs. The device may further comprise fourteen supply conduits, including the first and second supply conduits, each supply conduit being connected to at least one of the product inlets and an associated one of the reservoirs and configured to supply product to the respective reservoir. Each of the nine sector reservoirs may be connected to one, two or more (up to all) of the product inlets such that the associated reservoirs can be selectively placed in fluid communication with any of the one, two or more (up to all) product inlets.

The multi-product filling device may further comprise:
a plurality of reservoirs, including the first and second reservoirs, each reservoir being configured to contain a volume of product;
a plurality of filler valves, including the first and second filler valves, each filler valve being configured to dispense product into a container;
a plurality of filler conduits, including the first and second filler conduits, each filler conduit being connected to an associated filler valve and at least one of the reservoirs, for delivering product from the at least one of the reservoirs to the associated filler valve; wherein
each of the filler conduits associated with a filler valve is in mix-proof fluid communication with one two or more (up to all) of the reservoirs such that the associated filler valve can be selectively placed in fluid communication with any of the one, two or more (up to all) reservoirs. A multi-product rotary filling device, by default, may have an equal number of filler bows (reservoirs) as there are product inlets and the number of filler valves may also be a numeric multiple of the number of product inlets. Additionally the number of filler bowls which are furthermore segmented to cater for the optimum capacity processing of quantities of liquids less than the maximum (default) number of products is minimized to achieve those ends while minimizing the amount of equipment, cost and complexity. Additionally and in consideration of the filler bowl segmenting and mix-proof upstream product supply conduit fluid connections to alternate product inlets; measures for mix-proof filler valve fluid communication to filler bowl reservoirs different from the filler valve default filler bowl reservoir connection, are likewise minimized for a given number of different products of a multi-product rotary filling device is configured for (number of liquids x capacity of the filling device), to cater for the optimum capacity processing of quantities of liquids less than the maximum (default) number of products is minimized to achieve those ends while minimizing the amount of equipment, cost and complexity.

It will be appreciated that where filler conduits may be placed in selective communication with multiple reservoirs, there will be associated fluid circuit needs including associated automated valve and specifically mix-proof valve equipment, filler bowl, line and valve inter-connections, valve position feedback sensors, pneumatic actuation systems, control and SCADA (Supervisory control and data acquisition) system programming, as well as considerations concerning, cleaning, servicing and maintenance access. The configuration details of the aforementioned multi-product rotary filler device are a function, at least of, the number of product inlets, the number of filler valves (being a typically a multiple of the number of product inlets) and whether and to which extent supply conduit fluid mix-proof inter-connections to one or more bowl reservoirs and/or segmented bow reservoirs is implemented and/or whether and to what extent filler conduit fluid mix-proof inter-connections of filler valves to one or more of the said bowl reservoirs and/or segmented bow reservoirs is implemented. The execution of the above per multi-product filler execution (number of product inlets x capacity of the filler) would typically be optimized to meet the functional requirements of maintaining near filler capacity when running products different from one product, the full set of different products and any numbers of different product which are numerically a common denominator into the total number of product inlets into the filler. Clearly if no fluid inter-connections are applied, the full impact on filler capacity will be had when running anything different that the number of products which are not a common denominator in the number of product inlets. Upstream of filler bowl reservoir or downstream of filler bowl reservoir mix-proof fluid inter-connections eliminates or at least alleviates the filler capacity impact when running non-numerical denominator quantities of product vs the number of product inlets. It remains for persons skilled in the art to configure the system using the aforementioned filler valve mapping or filler bowl mapping techniques to achieved multi-product filling device configurations which meet the full or near full filler capacity requirements, regardless of the number of products being filled and to realise such at minimized cost and complexity.

The device may further comprise:
a plurality of product inlets for supplying a product to the device, including the first and second product inlets;
a plurality of filler valves associated with each reservoir;
wherein
   a plurality of the filler conduits are connected to only a single reservoir such that the corresponding filler valves can only be in fluid communication with the single associated reservoir;
   a plurality of the filler conduits are connected to a plurality of reservoirs such that the corresponding filler valves can be in fluid communication with any one of a plurality of reservoirs at a time, including the associated reservoir.

The corresponding filler valves being in fluid communication with a plurality of reservoirs, including the associated reservoir, is intended to mean that the filler valves may be provided in fluid communication with one of the plurality of reservoirs, which may be the associated reservoir, at a time for the duration of a given production run.

The device may, for example, comprise:
eight product inlets;
eight reservoirs;
wherein
   the filler valves associated with five of the eight reservoirs are connected only to the single associated reservoir;
   the filler valves associated with three of the eight reservoirs are connected to a plurality of reservoirs, including the associated reservoir.

The device may further comprise:
a third product inlet for supplying a product to the device;
a third reservoir configured to contain a volume of product;
a third supply conduit connected to the third product inlet and the third reservoir and configured to supply product to the third reservoir;
a third filler valve configured to dispense product into a third container;
a third filler conduit connected to the third reservoir and the third filler valve for delivering product from the third reservoir to the third filler valve;
a fourth product inlet for supplying a product to the device;
a fourth reservoir configured to contain a volume of product;
a fourth supply conduit connected to the fourth product inlet and the fourth reservoir and configured to supply product to the fourth reservoir;
a fourth filler valve configured to dispense product into a fourth container
a fourth fluid filler conduit connected to the fourth reservoir and the fourth filler valve for delivering product from the second reservoir to the second filler valve.

At least one of the first to fourth reservoirs may additionally connected to a further product inlet such that the at least one of the first to fourth reservoirs can be selectively placed in fluid communication with either of the respective first to fourth product inlets and the further product inlet; and/or
at least one of the first to fourth filler valves may additionally be connected to a further reservoir of the first to fourth reservoirs such that the at least one of the first to fourth filler valves can be selectively placed in fluid communication with either of the respective first to fourth reservoirs and the further reservoir.

Put another way, at least one reservoir and/or at least one filler valve may be networked. Advantageously, the filler valve(s) can therefore be used to dispense a wider variety of products (either by virtue of the reservoir being filled with that different product, or by the filler valve being connectable to a different reservoir filled with the different product).

At least one of the first to fourth reservoirs may only be connectable to a single product inlet; and/or
at least one of the first to fourth filler valves may only be connectable to a single product inlet.

Put another way, all filler valves may not be connected in the same way. At least a subset of the reservoirs may only be connected to a single product inlet. Alternatively, or in combination, at least a subset of the filler valves may only be connected to a single reservoir. It is preferable to reduce the number of connections, and (e.g. mix-proof) valves used, where possible, to reduce system cost and control requirements.

Some (e.g. at least one, a plurality of) filler valves may only be connected to a single reservoir. Some (e.g. at least one, a plurality of) reservoirs may only be connected to a single product inlet. Some (e.g. at least one, a plurality of) filler valves may be selectively connectable to one of a plurality of different reservoirs. Some (e.g. at least one, a plurality of) reservoirs may be selectively connectable to one of a plurality of different product inlets.

According to a second aspect of the invention there is provided a method of operating the multi-product filler device according to the first aspect of the invention, the method comprising:
placing the first filler valve in fluid communication with the first product inlet;
commencing a first filling operation;
dispensing the first product into the first container using the first filler valve;
finishing the first filling operation;
reconfiguring the multi-product filler device to place the first filler valve in fluid communication with the second product inlet;
starting a second filling operation; and
dispensing the second product into a further container using the first filler valve.

The multi-product filler is configured to fill one or more liquids at a time (e.g. between 1-8) and to do so with all products being filled in equal quantities per revolution of the rotary Filler for the duration of the production run. The said configuration is established before the start of the production run and maintained for the duration of the production run. Upon termination of a production run, the filler may be rinsed and/or CIP cleaned before being configured for maybe different product mix, number of flavours, and upon which would be run in that configuration for the next production run (i.e. each filler valve and each product handling, fluid contact surface would typically only handle one given product each, per production run (e.g. with rinsing and/or CIP cleaning occurring before resetting the configuration).

Specific embodiments of the present invention will now be described, by way of example only, with reference to the accompany drawings in which:

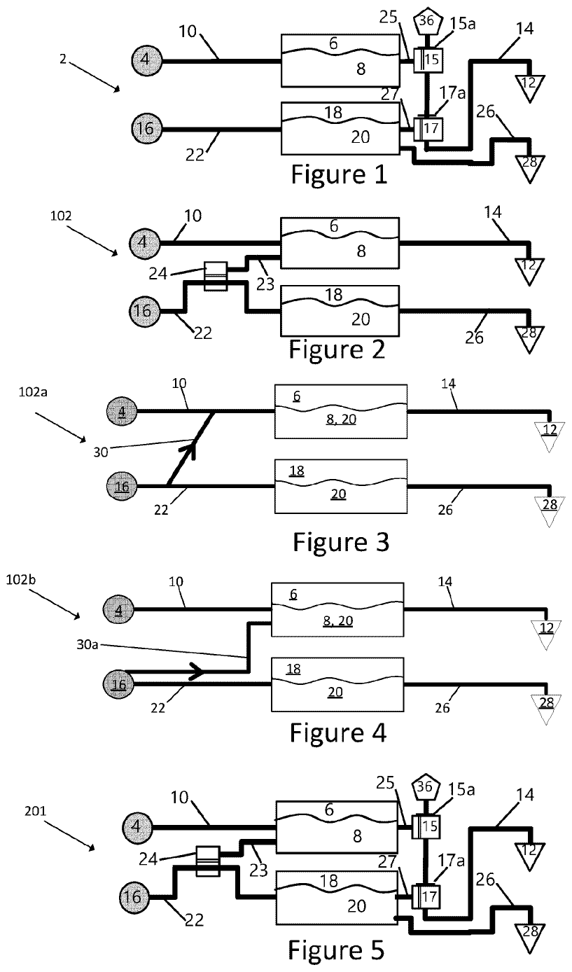

FIGS. 1-5 are schematic illustrations of embodiments of multi-product filler devices

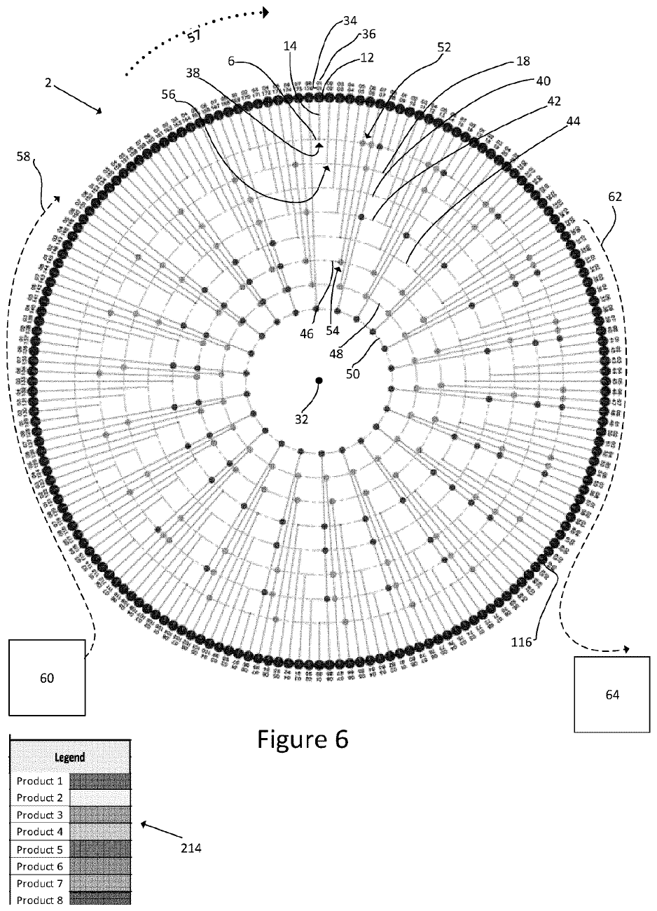

FIG. 6 is a schematic plan view of the multi-product filler device of FIG. 1;

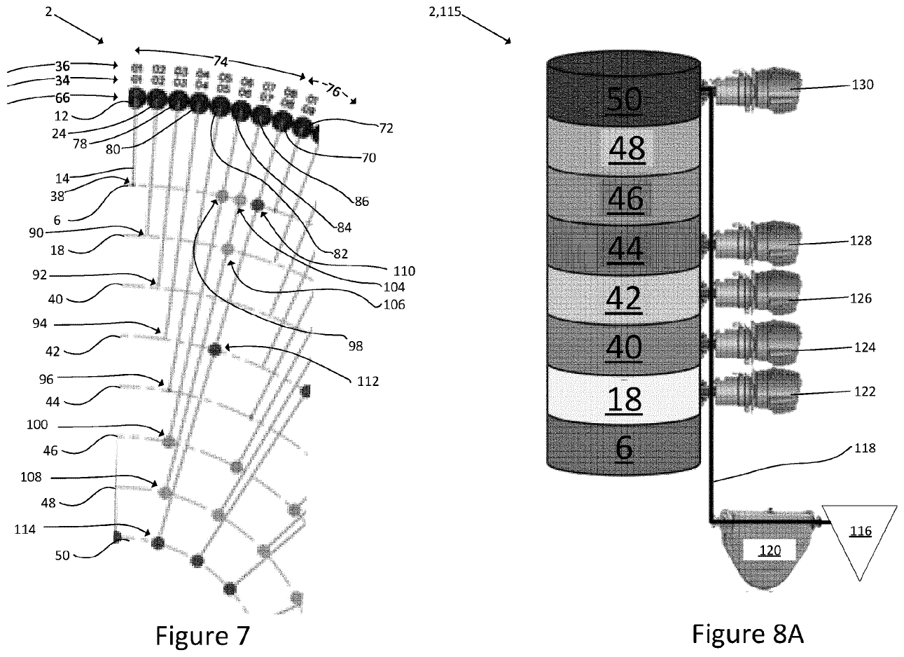

FIG. 7 is a magnified view of part of FIG. 6;

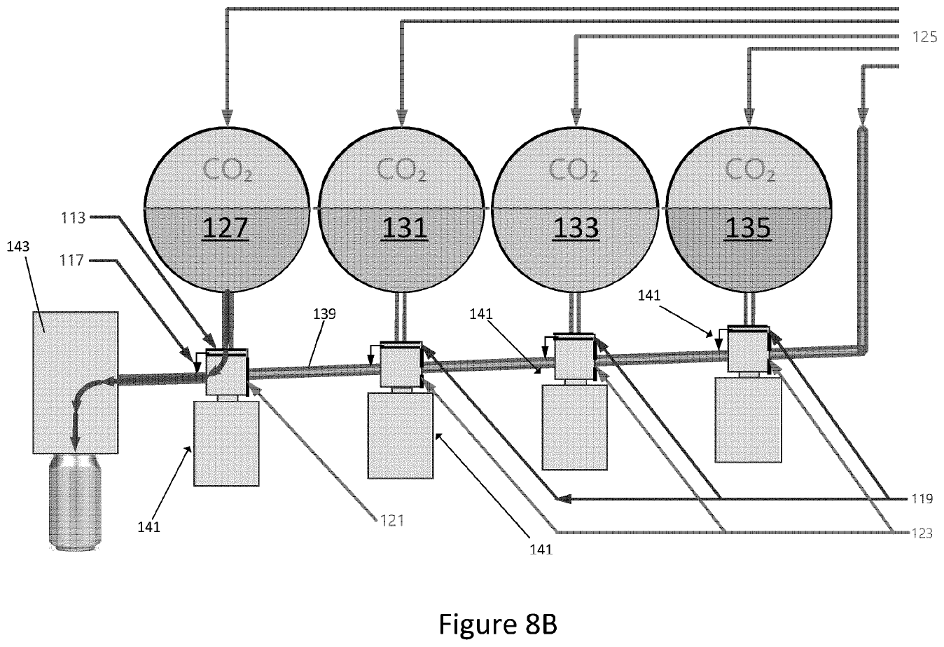

FIGS. 8A and 8B are schematic illustrations of a single branch of a filler device;

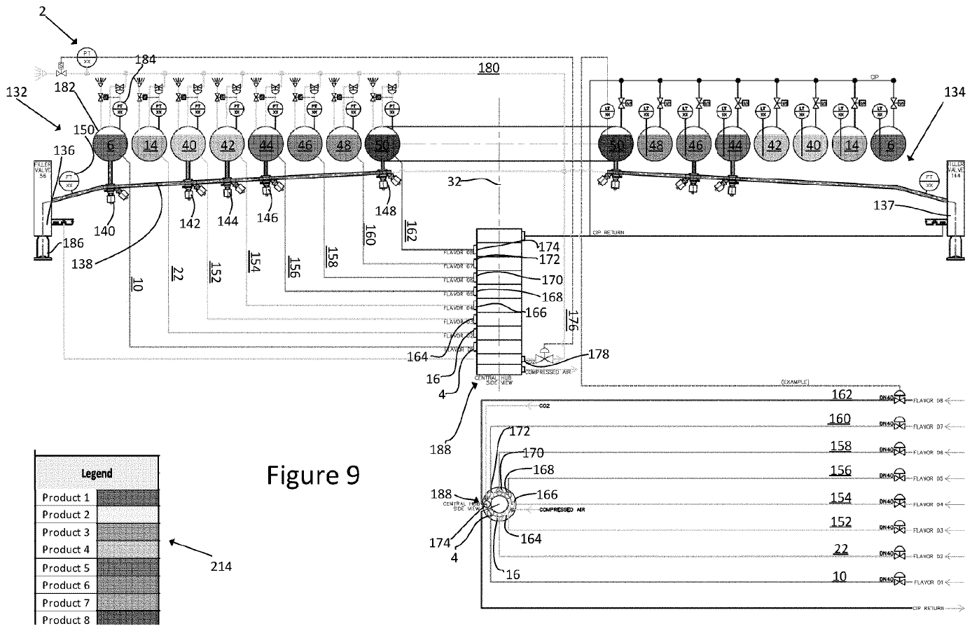

FIG. 9 is a cross section schematic illustration of the device of FIGS. 1 and 6;

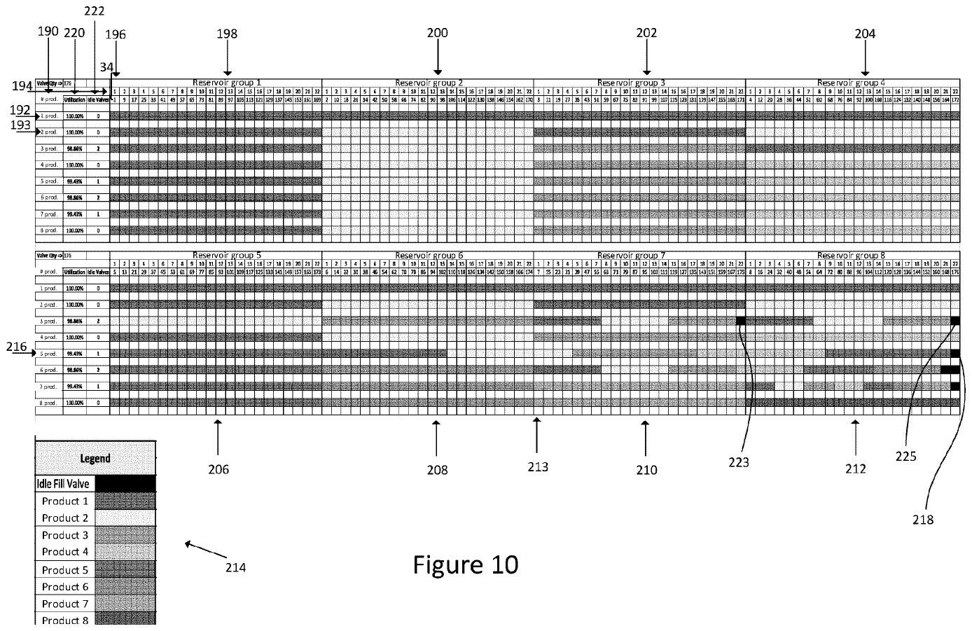

FIGS. 10-15 are tables mapping fluid connections between filler valves and reservoirs of the devices of FIGS. 1 and 6;

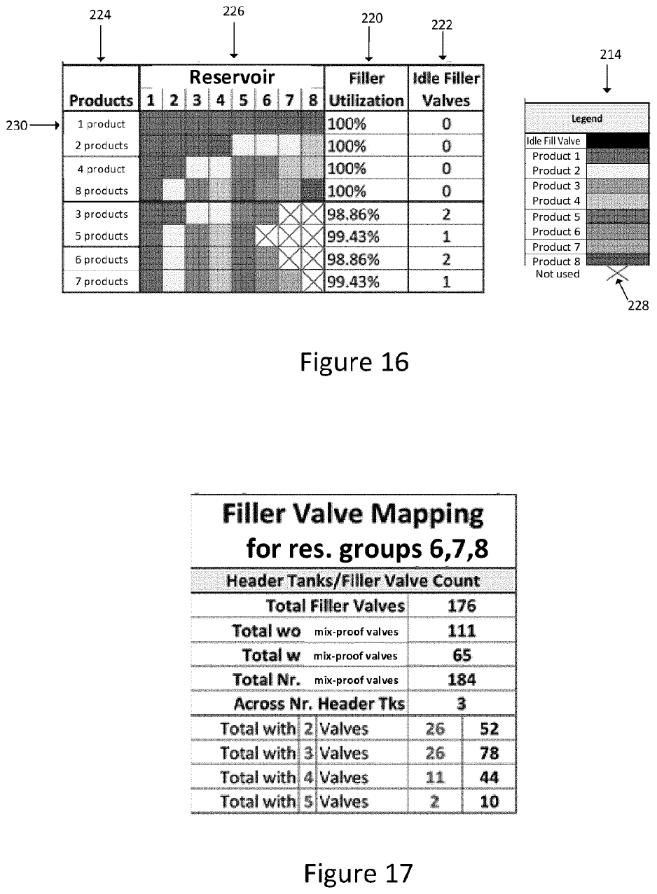

FIG. 16 is a summary table for the device of FIGS. 1 and 6, tabulating for the given 8 different product (8 reservoir) 176 valve rotary filler example, the number of different products run simultaneously vs the number of reservoirs utilized vs the percentage total filling capacity harnessed vs the number of filler valves from 176 not used;

FIG. 17 is a summary table for the device of FIGS. 1 and 6, tabulating for the given 8 reservoir, 176 valve rotary filler example, the number of Filling Conduits with or without mix-proof valve connections from other product reservoirs, the total number of mix-proof valves and details of how many of the said Product Conduits have 2, 3, 4 or 5 mix-proof valve connections;

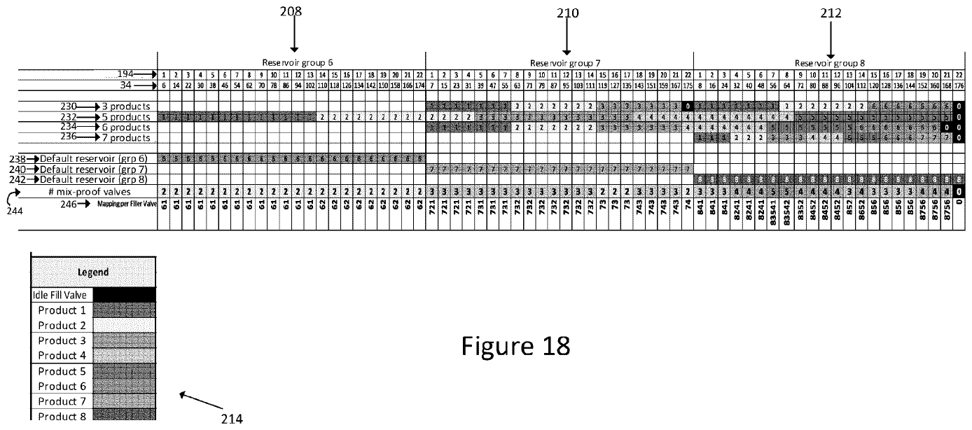

FIG. 18 shows the mapping of the device of FIG. 6 for filler valves of 6^{th}-8^{th} reservoir groups;

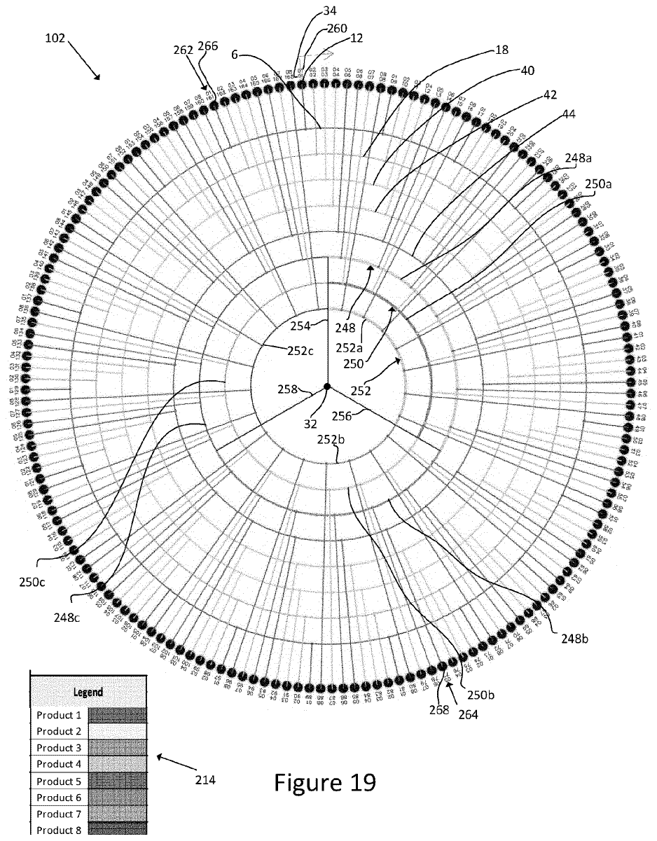

FIG. 19 is a schematic plan view of the multi-product filler device according of FIG. 2;

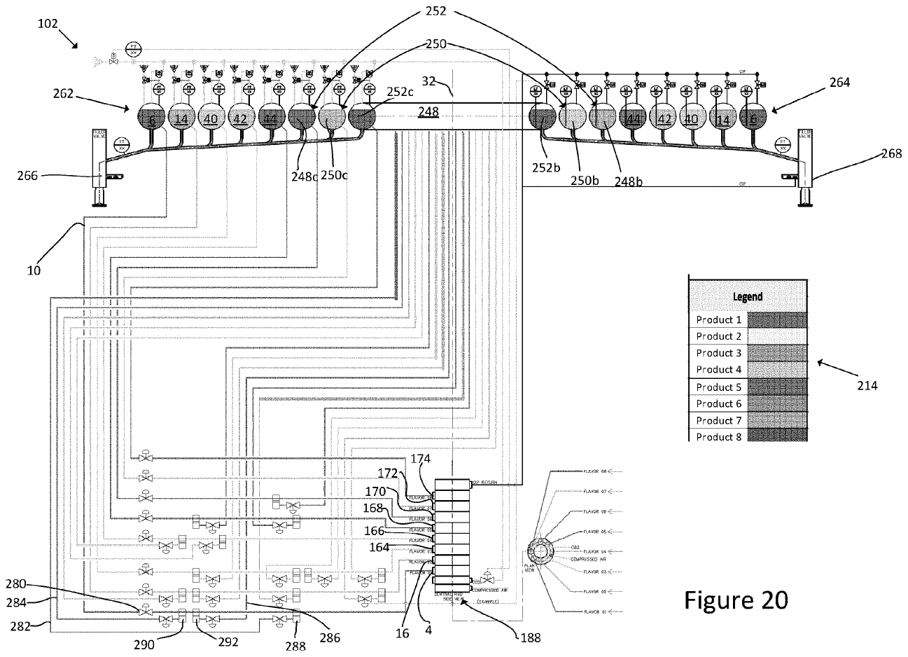

FIG. 20 is a cross section view of the multi-product filler device of FIG. 19;

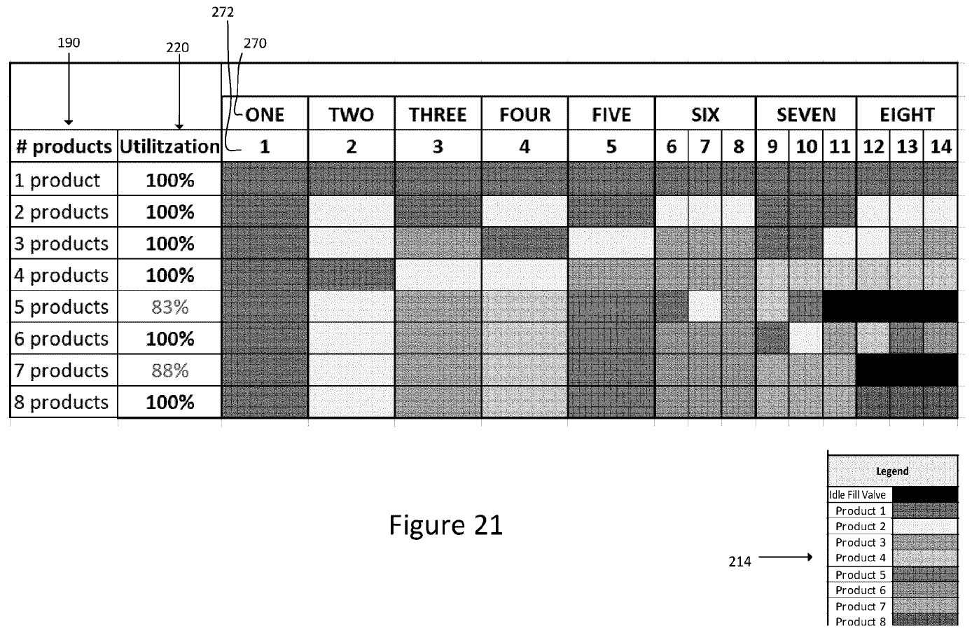

FIG. 21 is a summary table corresponding to the device of FIGS. 2 and 19, showing for the given 8 different product (8 reservoir) 176 valve rotary filler example, the tabulation of the reservoir and reservoir sector utilizations to accommodate the quantity of different products vs the percentage filler capacity utilization achieved and detailing the reservoir sectors not utilized when running 5 and 7 different liquid products; and

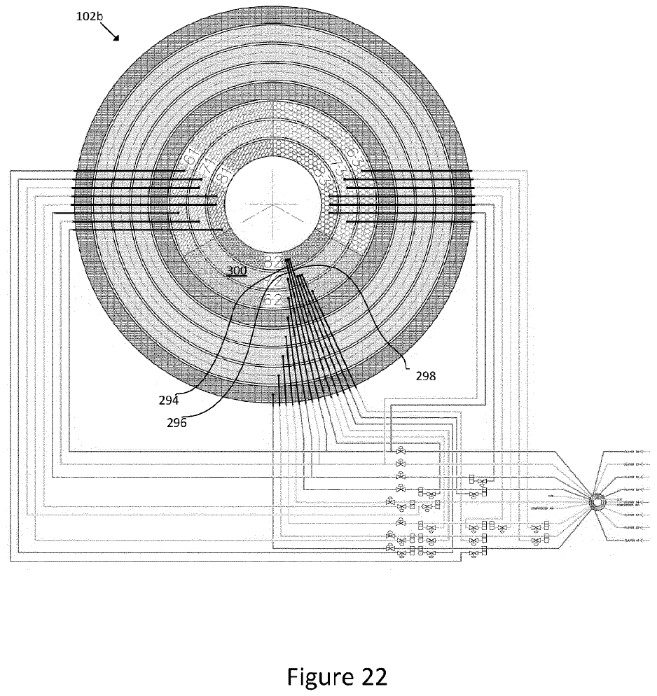

FIG. 22 is a schematic illustration with a plan view representation of an 8 annular reservoir rotary multi-liquid filling device, showing the mix-proof valve mapping of product from other product supply conduits fed from other product inlets to the respective reservoir sectors aligned with the execution according to FIGS. 2 and 19.

FIG. 1 is a schematic illustration of a multi-product filler device 2 according to an embodiment of the invention. FIG. 1 is included to aid in the explanation of the invention before more complex Figures, of comparatively larger devices, are described in detail.

Returning to FIG. 1, the multi-product filler device 2 comprises a first inlet 4 for supplying a (first) product. The filler device 2 further comprises a first reservoir 6 which is configured to contain a volume of product 8 (product 8 being a first product e.g. a first variety of product). The filler device 2 further comprises a first supply conduit 10 which is connected to, e.g. between, the first product inlet 4 and the first reservoir 6. The first supply conduit 10 is configured to supply product 8 to the first reservoir 6 from the first inlet 4.

The filler device 2 further comprises a second branch similar to that described above. The second brand comprises a second reservoir 18 which is configured to contain a volume of product 20 (product 20 being a second product e.g. a second variety of product). The filler device 2 further comprises a second supply conduit 22 which is connected to, e.g. between, the second product inlet 16 and the second reservoir 18. The second supply conduit 22 is configured to supply product 20 to the second reservoir 18 from the second inlet 16. The filling device 2 further comprises a first filler valve 12 and a second filler valve 28. Significantly, while the second filler valve is configured via second filling conduit 26 to be in fluid communication with second reservoir 18 to dispense product 20 into a container (no container shown in FIG. 1), the first filler valve 12 is configured via first filling conduit 14 (and via preferably mix-proof valves 15 and 17) to be in fluid communication with the first reservoir 6 and the second reservoir 18 via reservoir outlets 25 and 27, respectively, such that the first filler valve 12 may be configured to fill first product 8 from first reservoir 6 or second product 20 from second reservoir 18. The configuration for which product to dispense, i.e. from which reservoir, through first filler valve 12 (either product 8 from reservoir 6 or product 20 from reservoir 18) is set before and maintained for the duration of a given production run. The arrangement is described more detail in the sections below.

Examples of containers include cups, jars, bottles and cans. Of note, the first product 8 in reservoir 6, is different to that of the second product 20 in reservoir 18. For example, the first and second products 8, 20 may be different flavours of a given beverage, or maybe entirely different beverages. That said, in some embodiments multiple reservoirs may contain the same variety of product (e.g. in scenarios where a single product is to be dispensed by the device 2).

Of particular relevance to the present invention, is that filling conduit 14 of filler device 2 can be selectively placed in fluid communication with either first reservoir 6 (for product 8) or second reservoir 18 (for product 20). The fluid communication of filling conduit 14 with reservoirs 6 and 18 is preferably realised via mix-proof routing valves 15 and 17 located at the junctions of outlet 25 from first reservoir 6 and outlet 27 from second reservoir 18 with filling conduit 14, respectively. An example arrangement may be one in which filling conduit 14 is manifolded with the product reservoirs in an assured mix-proof manner that assured safe separation of the different liquid products is maintained. In one instance filling device 2 may be configured for the duration of a production run, for filler valve 12 to fill product 20 from reservoir 18, while at another occasion at another production run (after appropriate product rinsing and/or detergent cleaning), filling device 2 may be configured for the duration of a production run, for filler valve 12 to fill product 8 from reservoir 6.

That no dead leg (void) exists where product may remain stagnant and such that first product in is at all times the first out, the preferably mix-proof valves at the junctions between reservoir outlets 25 and 27 of reservoirs 6 and 18, respectively, and first filling conduit 14, preferably include the incorporation of valve isolation of the upstream unused portion (for that flow route configuration) of filling conduit 14. The isolation of the upstream, unused, portion of filling conduit 14 may be realised via a single seat valves (one per routing valve) integrated with the mix-proof routing valves 15 and 17, or the single seat isolation valves may be separate and close coupled with the mix-proof routing valves 15 and 17, respectively. The relationship between the (preferably) mix-proof product routing valves and the filling conduit isolation valves is that when the product (preferably) mix-proof product routing valve is closed, the associated filling conduit isolation valve is open, and visa versa when the (preferably) mix-proof product routing valve is open, the filling conduit isolation valve is closed. FIG. 1 displays the preferred execution of separate connections to reservoir 18, but if the reservoir nozzle entry were large enough to serve two of more reservoir outlets to two or more filling conduits, the reservoir outlets (e.g. 26 & 27) could (not recommended) share a common connection with the reservoir (e.g. 18). Described more broadly, the routing valves 15 and 17 linking first filling conduit 14 with reservoirs 6 and 18, respectively, effectively provides selective fluid communication between the reservoirs 6 and 18 and the first filler valve 12. Described another way, the first filler valve 12 is additionally connected, other than to the default first reservoir 6, also to the second reservoir 18. The first filler valve 12 can therefore be selectively placed in fluid communication with either of the first reservoir 6 or the second reservoir 18 for the duration of a production run. As previously described, where the second product 20 is different to the first product 8, this functionality can be used to effectively dispense a different product from a given filler valve, than the default product which the filler valve would normally dispense, the default reservoir being the vessel furthest away from the filling valve. For reasons which will become clear throughout the rest of this document, this functionality is particularly advantageous for being able to alter which product is dispensed from a filler valve, for the duration of a production run, where multi-product variety packs are being produced. Specifically, the filling device 2 can be reconfigured to set which product is dispensed from a given filler valve as required by the filling operation and for the duration of the specific filling operation (i.e. The product routing configuration of filling device 2 is set before the start and maintained for the duration of the filling operation) that regardless of the number of different products or product flavour variants being filled by filling device 2 (between 1 and the maximum number of liquids the filling device 2 is constructed for) the filling device 2 shall always operate at or very near (e.g. >98.5%) to full design capacity. That is to say, in an example where filling device 2 is constructed for a maximum of eight products, each product stream is routed, stored (reservoirs) and dispensed via the single filling device 2 in assured to be separate fluid communication channels (pipe, valves, reservoirs etc.) and regardless of whether one or any number of liquids through to eight are dispensed, the filling device 2 shall always operate at or very near to (>98.5%) of rated filling device 2 capacity. As may be appreciated from the above, the flexibility in filling between 1 and the maximum number of products filling device 2 is constructed for (e.g. 8), is realised via (preferably) automated mix-proof reservoir isolation routing valves and (preferably) automated single seat filling conduit isolation valves located downstream of the reservoirs, all of which rotate with the filler carousel of the rotary filler.

The number of reservoirs equals the number of individual product streams (products or product flavour variants) a multi-liquid filling device 2 may be constructed for (e.g. between 2 and 8, or more). The number of (preferably) mix-proof routing valves and associated upstream filling conduit isolation valves may therefore be between 2 and the maximum number of products the filling device 2 is constructed for (e.g. between 2 and 8, or more). In the case where a filling valve is in fluid communication with only one reservoir, there is no need for any routing valves nor upstream filling conduit isolation valves. In the case of the latter, the filling conduit places the filling valve 28 in direct fluid communication with the product supply reservoir 18 without any valves and without any intermediate reservoir outlet line. Stated another way, product routing valves connecting discharge lines from reservoirs to a given filling conduit are only applied if the filling conduit is in fluid communication with more than one reservoir, and noting that the variable equipment configuration is before a production run and maintained without any change at any time until the production run is concluded.

When a filling valve (e.g. 12) via the associated filling conduit (e.g. 14) is in selectable (i.e. one at a time per production run), fluid communication with more than one product supply reservoir (e.g. 6, 18), the said (preferably) mix-proof routing valves (e.g. 15, 17) with integrated (preferably) single seat upstream filling conduit isolation valves are installed, including the installation of a valve set for the default inner most reservoir (e.g. 6) of the co-planar annular shaped reservoirs. Unlike when a filling valve (e.g. 28) is in direct fluid communication via the associated filling conduit (e.g. 26) with just one reservoir (e.g. 18), when a filling valve (e.g. 12) is in selectable fluid communication via the associated filling conduit (e.g. 14) with more than one reservoir (e.g. 6, 18) via routing valves (e.g. 15, 17) and reservoir outlets (e.g. 25, 27) respectively, the upstream, redundant portion of the filling conduit (e.g. 14) is maintained under protective gas pressure by a dedicated gas, rinsing and CIP supply 36. The latter is only required when a filling conduit is in selectable fluid communication with more than one reservoir.

Turning to FIG. 2, a multi-product dispensing device filler device 102 according to a further embodiment is illustrated. Many of the features of the device 102 are shared in common with device 2, of FIG. 1, and will therefore not be described in detail. From FIG. 2, it will be appreciated that each of the first and second filler valves 12, 28 are only connected to a single reservoir 6, 18 respectively. The first and second filler valves 12, 28 can therefore only be placed in fluid communication with one of the respective first and second reservoirs 6, 18. This is in contrast to the device 2 of FIG. 1. In filling device 102 of FIG. 2, the ability to adjust which product is dispensed by the first filler valve 12 arises from the fact that the first reservoir 6 connected via supply conduit 10 to first product inlet 4, is also connected to the second product inlet 16 via an additional branch 23 forming part of supply conduit 10. The first reservoir 6 is connected to the second product inlet 16 via a reservoir linking conduit 23. The first reservoir 6 can therefore be placed in selective fluid communication with either of the first or the second product inlets 4 or 16, respectively. The first reservoir can therefore be supplied with either the first or the second products 8 or 20, for the duration of a production run. For completeness, it is anticipated that the first reservoir 6 be placed in fluid communication with only one of the respective product inlets 4 or 16, at any one time. After thorough rinsing and/or detergent CIP cleaning [Clean in Place] between production runs, and ahead of the next filling operation, the fluid connection or each product reservoir may be adjusted (e.g. such that the product contained within the first reservoir 6 be changed), i.e. in this case configured to be the same product 20 as the product 20 in the second reservoir 18.

Bearing some similarity to the device 2 shown in FIG. 1, the reservoir linking conduit 23 extends between the second supply conduit 22 and the first reservoir 6, or first supply conduit 10, in FIG. 2. As such, and as indicated in FIG. 2, the first reservoir 6 may contain either of the first product 8, emanating from the first product inlet 4, or the second product 20, emanating from the second product inlet 16. As previously mentioned, it is not anticipated that both products 8, 20 be contained within the reservoir 6 at any given time, but rather the reservoir 6 provides the functionality that either of the products 8 or 20 can be stored individually in the reservoir 6, for the duration of a production run. By virtue of the first reservoir 6 being selectively placeable in fluid communication with the second product inlet 16, it follows that the first filler valve 12 can therefore dispense either of the first or the second products 8 or 20 from the reservoir 6, depending upon the configuration of the product supply into reservoir 6 at the start of the production run. It will be appreciated that the first filler valve 12 will dispense whichever product is stored within the reservoir 6 at the time of dispensing.

It will be appreciated that in a hygienic food and beverage processing execution, that arrangement of flow component (pipes, valves, fittings etc.) enabling selective product supply for the duration of a product run, from either product inlet 4 via supply conduit 10 (and not from product inlet 16 via linking conduit 23 off supply conduit 22), or from product inlet 16 via linking supply conduit 30 off supply conduit 22 (and not from supply inlet 4 via conduit 10), is realised via the careful use of appropriate single seat and/or mix-proof valves, sized and assembled in appropriate orientation and close coupled (seat opposite port) assembly, ensuring the safe separation of different products and/or other media AND (preferably) the void free (no stagnant zones) product flow routing, respecting first product in, first product out, good hygienic engineering principles.

An exemplar execution of FIG. 2 would be as shown, whereby the alternative product supply to reservoir 6 via cross-link supply conduit 23 off supply conduit 22 from Inlet 16 is placed in fluid communication with reservoir 6 via a dedicated, separate, nozzle into the reservoir. Understanding that the product inlets 4 and 16 represent ports on the mix-proof central rotary hub of the rotary filling device 102, it will be appreciated that supply conduits, cross-link conduit/s, valves and routings etc. between the product inlets 4, 16 and the reservoirs 6, 18 occur in the rotary portion (carousel) of the rotary filling device 102.

Turning now to FIGS. 3 and 4, variant arrangements 102a and 102b of the device 102 of FIG. 2 are shown. In FIG. 4 the reservoir linking conduit 30a extends directly between the second product inlet 16 and the first reservoir 6. This is in contrast to the device 102a in FIG. 3 wherein the reservoir linking conduit 30 extends between the second and first supply conduits 22 and 10 respectively.

As described briefly above, the embodiment of FIG. 2 is a combination of FIGS. 3 and 4 where instead of linking conduit 30 connecting from supply conduit 22 to supply conduit 10, the linking conduit 23 connects from supply conduit 22 directly into reservoir 6 and thus having an independent connection into reservoir 6 than that of supply conduit 10, while still forming part of the wider first supply conduit network.

When considering an execution variation of supply conduit 30a, instead of supply conduit 30a linking product inlet 16 direct to reservoir 6, the linking conduit 30a may cross link from product 20 inlet 16 across to supply conduit 10.

The filling devices 102, 102a and 102b, shown in FIGS. 2, 3 and 4, illustrate variations of the invention in which the first reservoir 6 is in fluid communication with both the first product 8, and the second product 20, supplies. The associated first filler valve 12 can therefore dispense either the first product 8 or second product 20 depending upon which product is stored in the reservoir 6 owing to the fluid connection to either of the first or the second product supplies for the duration of a production run, i.e. the product supply is selected before the start and maintained for the duration of each production run. As mentioned above, it is expected that the products 8 or 20 only be stored in reservoir 6 individually (e.g. one or the other). It is not anticipated that the first reservoir 6 be actively fluidly connected to (i.e. actively receiving fluid from) both the first and second product inlets 4, 16, at the same time. Instead, it is expected that the reservoir 6 be in fluid communication with only one of the first or second product inlets 4 or 16, at any one time, they are, however connected to and thus have the ability to be selectively put in combination with the different product inlets.

Understanding that the product inlets 4 and 16 may represent ports on the central rotary hub of the rotary filling device 102a, and through which all products are supplied in a mix-proof manner, it will be appreciated that a product inlet 20 connection for reservoir 6 direct to the rotary hub via supply conduit 30a, either infers a cross connection of dedicated product 20 supply upstream of the rotary carousel of the rotary filling device 102a and thus a separate product supply channel through the rotary hub or the mounting of one or more (preferably) mix-proof valves and/or hygienic isolation valves (as would be identified and arranged by a person skilled in the art to ensure a hygienic execution according to best practices and to ensure safe separation of different products and/or media), directly at the product 20 inlet 16 from the rotary hub. The latter being on the rotary portion of the rotary filler carousel. Due to space constrains, especially if numerous reservoirs are to be connected to a given product inlet, the practicalities of an inlet 16 cross linked execution according to FIG. 4 (and FIG. 5) for the supply of product 20 are soon limited, thus steering more towards Figure C type executions where pipe supply conduit length can be realised for the insertion of the necessary mix-proof and single seat process valves.

From the explanations above it shall noted that there are two types of execution where by the filling device may be configured to dispense product 8 or product 20 through filling valve 12.
In the first instant, per FIG. 1, the filling conduit serving filling valve 12 is manifolded across more than one reservoir (e.g. reservoirs 6 and 18) and via routing valves may be placed in fluid communication with the reservoir containing the desired product to be filled.
In the second instant, per FIGS. 2, 3 and 4, filling valve 12 is in fixed fluid communication with reservoir 6 via a simple filling conduit 14 without flow routing valves and the product supply to reservoir 6 configured to be in selectable fluid communication with different product supplies via either
   linking supply conduits
      (e.g. 22 to 10 via link 30)
   linking an alternate product inlet to a supply conduit
      (e.g. Inlet 16 via link to supply conduit 10)
   linking an alternate product inlet directly to the reservoir
      (e.g. Inlet 16 via link 30a directly to reservoir 6)
   linking an alternate supply conduit directly to the reservoir
      (e.g. supply conduit 22 via link 23 directly to reservoir 6)

In other words, the arrangement for selectable product supply to filler valve 12 have been described when executed upstream of the reservoir or downstream of the reservoir. As may be immediately apparent, it may therefore be possible and functionally advantageous to realise a hybrid solution whereby both types of execution are present, as shown in FIG. 5.

The explanations of the various means of selectable product supply to filling valve 12, described via FIGS. 1-4, may encompass connections to/from multiple reservoirs making up a multi-product filling device, the aim of which is to realise the ability to dispense (fill) multiple different products simultaneously, in fixed proportion or disproportion, per revolution of the filling device while achieving full or near full (e.g. >98.5%) filling device design capacity utilization as all times, regardless of the number of different products being filled (between 1 and the maximum number the different products the filling device is configured for).

Turning to FIG. 5, a further embodiment of multi-product filler device 201 is schematically illustrated. The filling device 201 may be described as having a cross-networked arrangement both upstream of, and downstream of, the reservoirs.

The filling device 201 is effectively a hybrid arrangement of the devices 2 and 102 shown in FIGS. 1 and 2 respectively. With the device 201 it is possible to:
(1) selectively place the first reservoir 6, to which the first filler valve 12 is connected, in fluid communication with first or second product inlets 4, 16; and (separately and independently)
(2) selectively place the first filler valve 12 in fluid communication with either the first or second reservoirs 6, 18.

The FIG. 5 embodiment may be particularly useful for devices having a high number of branches. As can be appreciated, there various way and means of cross connecting product supply and product delivery systems upstream and downstream of the reservoirs. The choice of any execution being a factor of the number of (preferably) mix-proof product inlets via the rotary hub to be had, the number of connections to be made, space availability, cleanability, media and CIP (Clean in Place) routing and so on. The main function to be had is to network in a hygienic manner, the product supply to the product reservoirs and/or the product delivery from the reservoirs to the filling valves such that depending on which number of different products being filled at a given production run, the full or near full design capacity of the filling device is always realised, regardless of the number of different products or product flavour variants being run. Further to the above, the filler utilization is assessed upon the constraint that equal quantities of each product stream are filled and discharged from the filler at each revolution of the filling device 2 or 102 revolution. To be more precise, the products need not be discharged in any same product groups or repeating product order, but are required to be produced in equal quantities per revolution of the rotary filler carousel that upon packaging into variety packs the necessary quantity of each product making up each variety pack is available to the packaging operation in a constantly balanced mixed flow.

Turning to FIG. 6, a schematic plan view of an example multi-product rotary filler device 2 is provided. The FIG. 6 view depicts what is referred to as the filler valve mapping of the multi-product rotary filler device 2. That is, for a complete rotary filler device, a graphical map displaying or otherwise stating which filling conduits and hence filler valves, are manifolded to which reservoirs and which are simple filling conduits connected to associated filler valve direct to the associated (default) reservoir. For completeness, a cross section view through the device 2 is also shown in FIG. 9 and will be described in detail later in this document. A magnified view of a region of interest of FIG. 6 is provided as FIG. 7 and will again be described in detail later.

Returning to FIG. 6, FIG. 6 shows a rotary multi-product filler device 2 which is configured to rotate about an axis 32 in operation. FIG. 6 shows one non-limiting implementation of the rotary filler device 2.

In FIG. 6 there are two rows of number labels shown about the periphery of an example rotary filler device 2 displayed schematically in plan view, an inner series 34 labelling the filler valves sequentially from 01-176 (in this example of a 176 valve filling device 2) and an outer series 36, repeatedly indicating the default product e.g. 01-08 of (in this example) an eight liquid multi-product filling device. In FIG. 6, reference numerals 34 and 36 indicate valve number 1. Of note is that the maximum number of products is preferably a common denominator of the number of filler valves making up the filling device 2. In this example the filler valves are numbered in a clockwise direction, but could equally be numbered in a counter-clockwise direction. Likewise regardless of the filler valve numbering, the rotary filler device could be constructed for a clockwise or a counter-clockwise operation. Normally due to machine rotation, the filler valve numbering is applied in the opposite direction to the filler device rotation that at a given vantage point, the filler valve numbers increase from 01 to the max. number of filler valves as the periphery of the filler passes the observer. The aforementioned filler valve numbering scheme is also applicable when describing filling device 102.

Beginning first with a radially inner series of number labels 34, this series of number labels increasing from 01, in a clockwise direction, to 176. Each of these number labels indicates a unique identity number of each filler valve (e.g. per 12 in FIG. 1), (of the total 176 valves) associated with that particular filler branch. That is to say, the multi-product filler device 2 shown in FIG. 6 comprises 176 individual filler valves (e.g. per 12 of FIG. 1), each being provided as part of a respective radial filler branch. A filler branch being defined as the more of less radial sub-assembly of filler valve (e.g. 12), filling conduit (e.g. 14) and any routing valves (e.g. 12) and reservoir discharge connections (e.g. 25) to the routing valves associated with the product supply to the said filler valve (labels per FIG. 1). The filler valves (e.g. 12 of FIG. 1) provide the same functionality as those described in connection with FIGS. 1 to 5 in that they are configured to dispense products into an associated container. Preferably the total number of filler valves making up a rotary filler device is a multiple of the maximum number of different products the device is designed and constructed for. In the example 8 product 176 valve rotary filler device, there would be 22 filler valves per product distributed about the periphery of the filler device carousel. In other words, by default, before consideration of any filler valve mapping for the equally efficient and effective production of multiple products numbering less than (in this case) 8 products (max.) the filler device is design for, each reservoir is connected to by 22 filler branches serving 22 filler valves equally distributed about the circumference of the filler device.

Considering the default reservoir connections of this exemplary 8 product, 176 valve rotary filler device, the outer number series of FIG. 6 counts repeatedly in a clockwise direction (in this example) from 01 to 08 about the circumference of the filling device, starting at filler valve 01 (inner number series) and repeating 22 times (176 valves/8 Products=22 Repeats), terminating at valve 176. The inner number series tags the filler valves with unique valve numbers, starting at filler valve (and hence filler branch) 01 and counting clockwise (in this example) like that of the outer series, until termination at 176.

For clarity, when the first set of 22 filler valves and associated radial filler branches dispensing the first product from the first reservoir are laid out, evenly distributed about the filler circumference, and then the second set of laid out next to the former, and then the next and the next, up to 8 sets, totalling 22 repeats and 176 valves overall, the full filler device filler valve complement and equally distributed default connections to each of the 8 reservoirs, also evenly distributed about the circumference of the annular filler bowls (reservoirs) are also established. The inner number series 36 are therefore the unique valve numbers 1-176, while the outer series of 22× repeating numbers 01-08 refer to the default reservoir which the corresponding filler valve (inner series number) is connected to. Of note, is that with the introduction of mix-proof routing valves and the conversion of some filler conduits to manifolds placing the associated filler valve in fluid communication with more than one reservoir, when processing odd numbers of products for which the numerical number is not a common denominator of the maximum number of products the filler device is design and constructed for the different product sequence does not necessarily repeat and one or more filler valves may not be in use reducing slightly the percentage filler installed capacity utilization down slightly from 100%.

As stated above, the slight reduction in utilization of full installed filler device capacity only applies when processing quantities of products not a common denominator of the maximum number of products the filler device 2 is configured for, i.e. in the 8 product, 176 valve filler device 2 example, when running 1, 2, 4, 8 product flavours the quantities of products are common denominators of 8 and hence the filler device has the possibility to operate at 100% installed filler capacity. When running 5 or 7 products however, 1 filler valve becomes redundant, the filling sequence is not necessarily repeating and the overall filler device capacity utilization drops (because of the single redundant valve) to 99.43%. Likewise when running 3 or 6 products, 2 filler valves become redundant, the filling sequence is not necessarily repeating and the overall filler device installed capacity utilization drops (because of the two redundant filler valves) to 98.86%.

Of note is that while for non-common denominator quantities of products, the filling sequence may not repeat consistently, sequentially, about the periphery of the filler device, but per revolution of the filler carousel, equal quantities of each product shall be dispensed. In other words, to achieve the objective of always full or very nearly full filler capacity utilization regardless of however many products are being produced, the filler valve mapping is unrestrained in commanding the use of all available filler assets. The latter results in product dispensing sequences about the filler carousel which are not necessarily sequential nor consistently repeating; indeed, as one or more filler valves may not be in use, the resulting filler valve mapping may often result in two or more filler valves sequentially filling the same product and then there being gaps before the next occurrence of that product being filled again.

When the number of products being dispensed are numerically a common denominator of the maximum number of independent, mix-proof, fluid handling stream a filling device is designed to dispense, more than one fluid stream will be used to dispense the same product, thus harnessing the full capacity of the filling device.

The multi-product filler device may be described as a rotary primary container filling machine having multiple, reconfigurable, mix-proof, independent fluid handling, storing and dispensing channels which may be configured for the equal production of filled primary containers per production run, and in such a way that the full or very nearly full installed filler device production capacity is always realised, regardless of the number products being produced (up to the maximum number of different products the filling device is designed for) and that though the array of products filled may not necessarily be discharged in consistently repeating and/or sequential order, are always produced in equal quantity per fluid stream, per revolution of the rotary filler device carousel.

The radially outermost set of number labels 36 indicates groups of filler valves connected to a reservoir (reservoir group). The first filler valve in any reservoir group is being labelled 1. First filler valves are being labelled 1 by the label 36 therefore indicates that the first filler valves labelled “1” are connected to the first reservoir (e.g. 6 in FIG. 1) by default. For completeness, the first filler valve (e.g. 12 in FIG. 1) is in fluid communication with the first reservoir (e.g. 6 in FIG. 1) via the first filler conduit (e.g. 14 in FIG. 1) each of the filler conduits being radially arranged in the illustrated embodiment. The numerals used here mirror those used in FIGS. 1 to 4, in which schematic illustrations of multi-product filler devices were provided and described. In FIG. 6, a node 38 indicates that the first filler conduit 14 is fluidly connected to the first reservoir 6.

The feature labelled 6 is a first reservoir in FIG. 6. The first reservoir 6 is a radially outermost reservoir of a total of 8 reservoirs. In the illustrated embodiment each reservoir takes the form of an annular bowl which extends around the axis of rotation 32. Advantageously, the use of the annular bowl means that a single reservoir 6 can be placed in fluid communication with a plurality of different filler valves (at least 22 in the illustrated embodiment with 176 valves).

Turning briefly to consider the other reservoirs, moving radially inwards from the first reservoir 6, a second reservoir 18 is provided. Continuing to move radially inwards from the second reservoir 18, there are provided a third reservoir 40, fourth reservoir 42, fifth reservoir 44, sixth reservoir 46, seventh reservoir 48 and eighth reservoir 50. As previously mentioned, and repeated here again, FIG. 9 is a cross section view showing the concentrically arranged nature of each of the reservoirs. For reasons which will be explained in detail, the various indicated nodes 38, 56 etc. (only some of which are labelled) between the various filler conduits show the fluid connections of the various filler conduits to the various reservoirs. Whilst many of the filler conduits, and so filler valves, are only connected to a single reservoir, various filler conduits (e.g. a subset of the filler valve conduits) are provided in selective fluid communication with a plurality of reservoirs. For example, through nodes 52, 54 the filler valve identified by the label 6 in both the radially inner and outer label rings 34, 36 is provided in fluid communication with both the first reservoir 6 and the sixth reservoir 46. For completeness, in FIG. 6 any nodes for filler conduits for a given reservoir group (e.g. filler valves sharing the same number label in the radially outer number label series 36) are indicated by a common node. For example, when comparing filler valves labelled 1 and 2 it will be appreciated that the node 38 differs to that of the node 56. The nodes are marked according to the default product stored in that reservoir, as indicated by the legend 214. For example, the node 38 is indicated to correspond to the first product because, by default, the first reservoir 6 is for storing a first product. For any filler valve/conduit with multiple nodes (indicative of fluid connections to multiple reservoirs), each node represents a mix-proof valve. For any filler valve/conduit with a single node (indicative of a fluid connection to only a single reservoir), each node simply represents a fluid connection to that reservoir.

The provision of eight separate reservoirs means that the multi-product filler device 2 can be used to dispense up to eight different products. That is, each of the eight reservoirs may contain a volume of different product (e.g. the first reservoir 6 may contain a first product, the second reservoir 18 may contain a second [different] product etc.). Alternatively, multiple reservoirs may contain the same product in instances where eight different products are not required (e.g. in the case of a multi-product multipack having four different flavours [e.g. four different products only]). Alternately when the number of different products being filled is less than the maximum number of products a multi-product filler device is designed for and more than one (same) product across all reservoirs (and hence filling conduits and filling valves, with each product in one or more dedicated reservoirs), the product supplies are equally distributed about the total number of filling valves that for each rotation of the filler device, equal quantities of product are dispensed, per revolution of the filling device. In doing so, a balanced but mixed flow of the number of different products is dispensed and filled into the primary packaging (cups, jars, bottles or cans) into the downstream packaging line. The mixed flow of filled, sealed and coded primary containers being further processed and inspected before being continuously sequenced into the appropriate order for packaging into multipacks (variety packs) with each with the desired array of different products or product flavour variants packed into each pack and in the designated position within each pack.

Also schematically indicated on FIG. 6 is (part of) a path 58 taken by a container to be filled by a respective filler valve. As the multi-product filler device 2 rotates about the axis 32, a container is received at the multi-product filler device 2 from an infeed supply 60. In preferred embodiments the container to be filled arrives at the multi-product filler device 2 and remains associated with one particular filler valve. That is to say, the container moves along an arcuate path sharing the axis 32 as an origin and having the same rotational speed as the device 2. Described another way, once the containers are received proximate the associated filler valve, there is no relative rotation between the container and the respective filler valve for the duration of the filling process (e.g. whilst the container is being filled). This means that the container can be filled whilst the device 2 rotates, meaning that the device 2 can fill a high number of containers in a continuous manner. The supply of containers which follow the path 58 are received from the infeed supply 60. Also schematically indicated on FIG. 6 is a further portion of a path 62 taken by the containers as the multi-product filler device 2 continues to rotate. At the point where the (now-filled) containers separate from the multi-filler device 2, the containers proceed to an outfeed 64.

Turning to FIG. 7, a magnified view of part of the mapping diagram shown in FIG. 6 of the multi-product filler device 2 is provided. FIG. 7 effectively shows a sector of the overall valve map which extends round to a filler valve labelled 9 (e.g. to 9^{th} filler valve 72). The mapping diagram shows, at the radially inner sequence of number labels 34, a number label which identifies one filler valve 66 of all of the filler valves forming part of the multi-product filler device 2. As previously mentioned, the first filler valve 12 is therefore labelled 1 in the number label sequence 34, which is also annotated 12 for completeness. The first filler valve 12 is shown connected to the first reservoir 6 via first filler conduit 14. The node 38 indicates that the first filler conduit 14 is connected to the first reservoir 6. Second to eighth reservoirs, which are concentrically arranged radially inwardly and co-planar of the first reservoir 6, are also labelled 18 and 40 to 50. As previously mentioned, in the illustrated embodiment the reservoirs take the form of annular bowls which extend concentrically around the axis of rotation (hub), each reservoir being one separate bowl. That is to say, none of the bowls are segmented.

Looking to the radially outer number sequence 36, it is observed that the reservoir group number 36 increases from 1, corresponding to the first filler valve 12, to 8, corresponding to an eighth filler valve 70. The reservoir group number then restarts from 1 at the ninth filler valve 72. For the filler valves 12, 24, 78 to 86 and 70, for which the reservoir group number increases from 1 to 8 in the number series 36, these filler valves belong to a first sector group 74 of filler valves. The sector group can be considered to represent sequential filler valves which, when an eight product multi-product multipack is being filled, correspond to the filled containers for one entire multi-product multipack. That said, as mentioned above it is not always the case that eight separate products be dispensed from each of the eight filler valves 66 belonging to one sector group 74.

Moving in a clockwise direction beyond the first sector group 74, the ninth filler valve 72, for which the reservoir group number 36 resets to 1, forms part of a second sector group 76 (only one filler valve 72 of which is visible). When comparing the magnified view of FIG. 7 with the overall view of FIG. 6, it will be appreciated that the multi-product filler device 2 as illustrated in FIG. 6 comprises a high number of sector groups and, in the illustrated embodiment, specifically has 22 sector groups. The 22 different sector groups multiplied by 8 filler valves per group determines the 176 total filler valves forming part of the device 2. In other words, the total number of filler valves is preferably a multiple of the maximum number of products the multi-product filling device is designed to continuously process. Alternatively stated, the maximum number of products a multi-product filling device processes is preferably a common denominator of the total number of filling valves making up the filling device. When filling a quantity of products which number less than the maximum number of products a multi-product filling device is designed and constructed for, the dispensing of the said lower number of different products is distributed about the periphery filler valves of the rotary filler that at all times, the rated filler capacity is achieve or very nearly achieve.

Returning to FIG. 7, the actual mapping of the various filler valves to the various reservoirs (for this example of a filling device 2) will now be discussed. The first filler valve 12 is provided in fluid communication with the first reservoir 6 (only) via the first filler conduit 14. This is indicated by node 38. The second filler valve 24 is provided in fluid communication with the second reservoir 18 (only), as indicated by node 90. Third, fourth and fifth filler valves 78, 80 and 82 are also each provided in fluid communication with third, fourth and fifth reservoirs 18, 40, 42 respectively (only) via nodes 90, 92, 94.

Each of the first to fifth filler valves is therefore provided in fluid communication with a single reservoir (which may be described as each of the first to fifth filler valves only being associated with a single reservoir). That reservoir corresponds to the reservoir group 36 of that filler valve 66 (e.g. the first filler valve 12 is labelled 1 in the reservoir group 36 because it is provided in fluid communication with the first reservoir 6 by default).

For sixth filler valve 84, a plurality of selective fluid communication points are introduced. Specifically, the sixth filler valve 84 can be placed in in selective fluid communication with either of the first reservoir 6 (via node 98) and the sixth reservoir 46 (via node 100). The sixth filler valve 84 can therefore be provided in fluid communication with either of the first and sixth reservoirs 6, 46. The selection occurs by way of the selective opening and closing of associated valves represented by the nodes 98, 100. The reasons for the specific selection of reservoir connections will be described in detail later in this document. The sixth filler valve 84 can therefore be considered to be in fluid communication with the default sixth reservoir 46, but can alternatively be placed in fluid communication with the first reservoir 6.

Turning to consider seventh filler valve 86, the seventh filler valve 86 is provided in fluid communication with the seventh reservoir 48 via a node 108. However, the seventh filler valve 86 is also connected to both the first reservoir 6, via node 104, and the second reservoir 18 via node 106. The seventh filler valve 86 can therefore be placed in selective fluid communication with any of the first, second and seventh reservoirs 6, 18, 48. Turning finally to the eighth filler valve 70, the eighth filler valve 70 can be provided in selective fluid communication with any of the eighth reservoir 50 (via node 114), the fourth reservoir 42 (via node 112) and the first reservoir 6 (via node 110).

Unlike the first to fifth filler valves, which are provided in selective fluid communication with only a single reservoir, each of the sixth, seventh and eighth filler valves 84, 86, 70 are connected to a plurality of reservoirs, and can be placed in selective fluid communication with any one of those connected reservoirs, and fixed for the duration of the production run before rinsing and/or detergent cleaning before an alternative selection can be made and locked in place (maintained) for the next production run.

Turning now to FIG. 8A, a first schematic illustration of a single branch 115 of the multi-product filler device 2 is shown. Branch 115 comprises a filler valve 116, which corresponds to the sixty-fourth filler valve of FIG. 6, a flow meter 120 and filler conduit 118. The filler conduit 118 extends between the reservoirs and the filler valve 116. The flow meter 120 is provided in line with the filler conduit 118 and upstream of the filler valve 116. Although FIG. 8A is useful in illustrating the principle of valve mapping, it is noted that the reservoirs are arranged in a vertically stacked arrangement as opposed to the concentrically aligned arrangement as shown in, for example, FIGS. 6, 8B and 9. However, it will be appreciated that the FIG. 8A arrangement can equally be applied to a concentrically arranged reservoir arrangement, as schematically shown in FIG. 8B. FIG. 8A shows the first and second reservoirs 6, 18 and third to eighth reservoirs 40 to 50 respectively. Briefly, FIG. 8A also shows flow meter 120. In this example, the function of the flow meter 120 is to meter the amount of product which flows through the filler conduit 118 to the filler valve 116 and thus manage the operation of the filling valve for the precise dispensing of product per primary container (cup, jar, bottle, can). Other means dispensed product quantity control also exist such a volumetric dispensing and fill level dispensing.

It will be appreciated that control of the filler valve 116 determines the volume of product which is dispensed into a given container. It will also be appreciated that it is desirable to be able to accurately control the volume of product which passes through the filler valve 116. The filler valve 116 is thus linked to a controller, which transmits a signal to control operation of the filler valve 116. As indicated in FIGS. 7 to 9, the distance along which product flows, between a given reservoir and the filler valve 116, depends upon the reservoir (and so the product in question). That is to say, a first product may have a greater distance to travel (from a respective reservoir), to the filler valve, than a second product (from a respective reservoir). The filer valve 116 is therefore operated to compensate for this difference in pipe lengths and other considerations giving rise to variations in flow resistance, by making minor adjustments to the timing of the filler valve 116 operation. This means that, irrespective of which product is to be dispensed, and which reservoir the product is stored in, the volume of product dispensed is managed to remain uniform. This is made easier by providing all reservoirs at the same plane (i.e. same height) to reduce variation of hydrostatic head of the products stored therein. The filler valves are preferably electronically controlled.

The branch 115 shown in FIG. 8A illustrates how the filler valve 116 is connected to each of the second reservoir 18, third to fifth reservoirs 40, 42, 44 and the eighth reservoir 50. The filler valve 116 can therefore be placed in selective fluid communication with any one of the connected reservoirs. That is to say, the filler valve 116 is not connected to, and so cannot be placed in selective fluid communication with any one of, the first, sixth or seventh reservoirs 6, 46, 48. This mapping is confirmed by looking to the sixty-fourth filler valve 116 as labelled in FIG. 6 and following the associated mapping.

The filler valve 116 is provided in selective fluid communication with the relevant reservoirs by a respective mix-proof valve. Specifically, the filler valve 116 is provided in selective fluid communication with the second reservoir 18 via a first mix-proof valve 112, with the third reservoir 40 by a second mix-proof valve 124, with the fourth reservoir 42 via a third mix-proof valve 126, with the fifth reservoir 44 via a fourth mix-proof valve 128 and with the eighth reservoir 50 via a fifth mix-proof valve 130. The mix-proof valves are so called because they have desirable leak-proof characteristics even in the event of a valve failure, reducing the risk of undesirable product mixing (assuming different products are stored within the relevant reservoirs).

From FIG. 8A it will be appreciated that the filler valve 116 is only connected to a single filler conduit 118. However, as mentioned above, that single filler conduit 118 can be placed in selective fluid communication with one of a plurality of different reservoirs. Each filler valve of the multi-product filler device 2 is preferably connected to only one (i.e. a single) filler conduit. Put another way, each filler valve preferably has a corresponding single, individual filler conduit connected to it. That one (single) filler conduit, for each filler valve, is then connected or connectable to one or more reservoirs. Some filler conduits may only be connected or connectable to a single reservoir, others may be selectively connectable to one of a plurality of different reservoirs (e.g. by way of mix-proof valves, as described in connection with FIG. 8A). It will be appreciated that, by virtue of each filler valve being connected to a given filler conduit, where the filler conduit is described as being connected or connectable to one or more reservoirs, the filler valve is also connected or connectable to one or more reservoirs (albeit indirectly).

FIG. 8B is a further schematic illustration of a single branch of a filler device according to the disclosure. Four reservoirs 127, 131, 133, 135 are shown. Each reservoir is a concentric annular bowl and each is connected to an individually controlled CO2 supply 125. A conduit 139 connects to the filler valve 143 for supplying beverage to the filler valve 143. For this particular filler valve 143, each of the reservoirs 127, 131, 133, 135 is connected to the conduit 139 via mix-proof valves 141. The mix-proof valves employ a line stop valve 121 to selectively prevent flow through the conduit 139 to isolate the upstream conduit 139 and selectively permit flow through the valve 123. The mix-proof valve 141 is also configured to selectively permit 113 and prevent 119 flow out of the reservoirs 127, 131, 133, 135.

In the arrangement shown in FIG. 8B, the mix-proof valves 141 are configured to put the filler valve 143 into fluid communication with only one of the reservoirs 127, while preventing flow from the other reservoirs 131, 133, 135. In order to ensure reliable operation, a vent 117 is provided between the two seals (i.e. reservoir and conduit seal) of the mix-proof valve. The filler valve 143 schematically illustrated in FIG. 8B does not correspond to a specific filler valve of the example of FIG. 6, but is rather an illustrative schematic.

Turning to FIG. 9, a cross section schematic illustration of the multi-product filler device 2 is provided. FIG. 9 shows two separate branches of the multi-product filler device 2, the filler device 2 having (in this example) a total of 176 branches (e.g. one branch for each filler valve). A 56^{th} branch on the left hand side of FIG. 9 is labelled 132 and corresponds to the 56^{th} filler valve 136 as labelled in FIG. 6. Located diametrically opposite the 56^{th} branch 132, a 144^{th} branch 134 is shown. The 144^{th} branch 134 is associated with a 144^{th} filler valve 137. For brevity, the 144^{th} branch 134 will not be described here in detail. The filler valves 136, 137 dispense product into a container. Of note is that diametrically opposite filler branches need not be manifolded to filler reservoirs the same. In other words, the mapping of any filler valve to whichever reservoir/s, is independent of the mapping of any other filler valve and a function rather of the overall filler valve mapping for optimum production capacity regardless of however many products are being produced within the max. number of products the filling device 2 is designed for.

Returning to the 56^{th} branch 132, as previously mentioned the branch 132 comprises the 56^{th} filler valve 136 (herein referred to as the filler valve). An associated container 186, into which a volume of product is dispensed by the filler valve 136, is also shown. The branch 132 further comprises a filler conduit 138 and a flow meter 150. As previously described in connection with earlier Figures, each of first to eighth reservoirs 6, 14 and 40 to 50 are also shown. In the illustrated embodiment these reservoirs are co-planar and arranged in a concentric manner (e.g. the same eighth reservoir 50 serves both the 56^{th} branch 132 and the 144^{th} branch 134, as well as other branches not displayed in FIG. 9). The cross-section of the eighth reservoir 50 being an annular bowl, as are the other reservoirs, is visible in FIG. 9. The annular reservoirs are concentric and co-planar about the common axis along which, above, aligned or below, the mix-proof product inlet hub 188 is located (illustrated below the annular reservoirs in FIG. 9).

The branch 132, dispensing product to filler valve 136, is in selective fluid communication with each of first, third, fourth, fifth and eighth reservoirs 6, 40, 42, 44, 50 via mix-proof valves 140, 142, 144, 146, 148, respectively. For ease of explanation here, each of the different reservoirs can be considered to contain a different product (see also key 214). The filler valve 136 can be placed in selective fluid communication with (one of) the aforementioned plurality of reservoirs via a respective mix proof valve of first to fifth mix-proof valves 140 to 148. Owing to this arrangement, before a given production operation, the filler valve 136 can be configured to deliver any of the first, second, third, fourth or eighth products (stored in the respective reservoir) as needed, and that configuration maintained for the duration of the filling operation, the configuration only being changed only upon rinsing and/or detergent cleaning of the filling device 2 before the next filling operation. Although not shown, in other embodiments each mix-proof valve may be paired or integrated with an isolation valve to effectively isolate the respective reservoir from the upstream filler conduit. That if to say, a normally open valve filling conduit valve is paired (close coupled) or integrated with each normally closed (preferably) mix-proof valve connecting the outlet from a product reservoir to a filling conduit. When the normally closed mix-proof valve is opened, the normally open filling conduit isolation valve is closed, thus isolating the upstream (unused) portion of filling conduit, beyond the reservoir mix-proof routing valve, and thus avoiding any void in which product may become stagnant. This advantageously ensures no voids or dead legs in the product supply through to the filler valve.

The first to eighth products, associated with each of the first to eighth reservoirs, are supplied to the respective reservoir by a respective supply conduit. First and second supply conduits 10, 22 connect the first and second reservoirs 6, 14 to the first and second product inlets 4, 16 respectively. Correspondingly, the third to eighth reservoirs 40, 42, 44, 46, 48, 50 are supplied with third to eighth products respectively, from respective product inlets 164, 166, 168, 170, 172, 174, by respective supply conduits 152, 154, 156, 158, 160, 162. As previously described, in this embodiment each of the reservoirs are supplied with a single product in operation (e.g. each reservoir, an annular bowl in this arrangement, contains a particular product). Each of the various product inlets are provided as part of a mix-proof supply column (rotary hub) 188. As will be appreciated from the lower part of FIG. 9, when viewed from underneath the supply column 188 provides each of the respective product inlets radially along and about the circumference of the column. The supply column 188 further provides a supply of carbon dioxide (CO₂) to the rotating filling device carousel whereupon it is piped, pressure controlled and distributed to each filler valve 136, to each of the first to eighth reservoirs and various other application points within the rotating carousel of filling device 2. CO₂ is supplied to the filler valve 136 via a filler valve CO₂ supply conduit 176 from the CO₂ inlet 178. The CO₂ is used to flush containers of air and to pressurise the containers as well as the reservoirs and product distribution systems (e.g. product dispensing branches and filling valves), as part of the filling process for e.g. oxygen sensitive, carbonated products. CO₂ is supplied to each of the reservoirs via one or more reservoir CO₂ supply conduits 180. The reservoir CO₂ supply conduit 180 branches off to each reservoir at an inlet of the respective reservoir, with only a first inlet 182 of the first reservoir 6 being labelled in FIG. 9. CO₂ pressure control is applied centrally and/or opposite each category or individual CO₂ consumption or application point. For completeness, each of the reservoirs further comprises a level sensor 184 (only the sensor of the first reservoir 6 being labelled in FIG. 9). The level sensor 184 provides information on the level of product currently stored within the relevant reservoir and feedback to flow control and flow isolation devices necessary for the precise management of constant level (and hence constant static head) within each reservoir. The CO₂ is a protective blanketing gas and also used for product carbonation, but could equally be any other inert gas, the same or different from the carbonation gas, e.g. nitrogen (N₂).

As will be appreciated from FIG. 9, each of the first to eighth reservoirs 6, 14, 40, 42, 44, 46, 48, 50, respectively, are located in the same plane and are concentrically arranged with one another. Significant variations between the hydrostatic head of the products in each of the reservoirs is thus avoided. Control of the filler valves is thus made more straightforward.

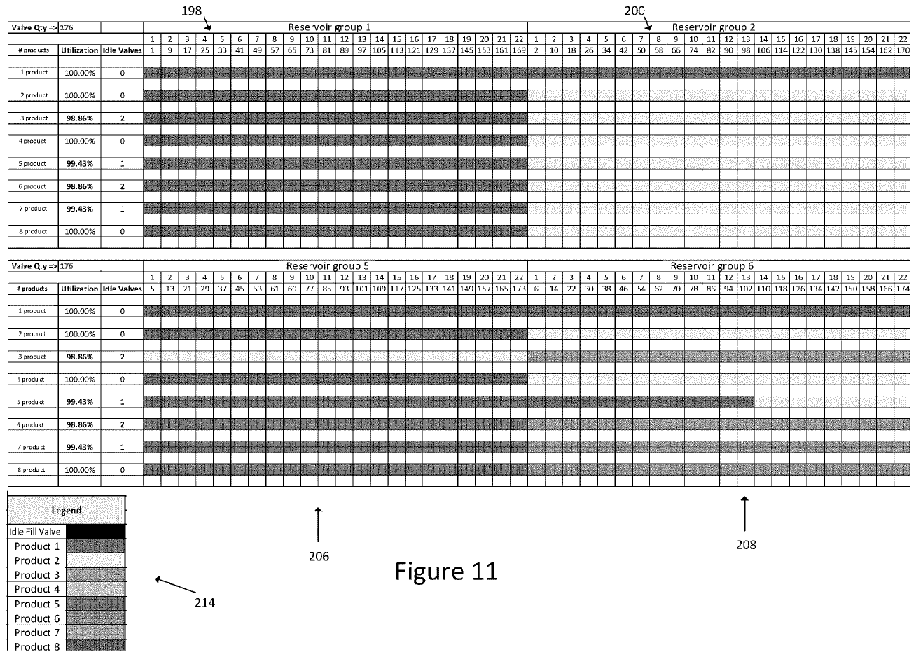

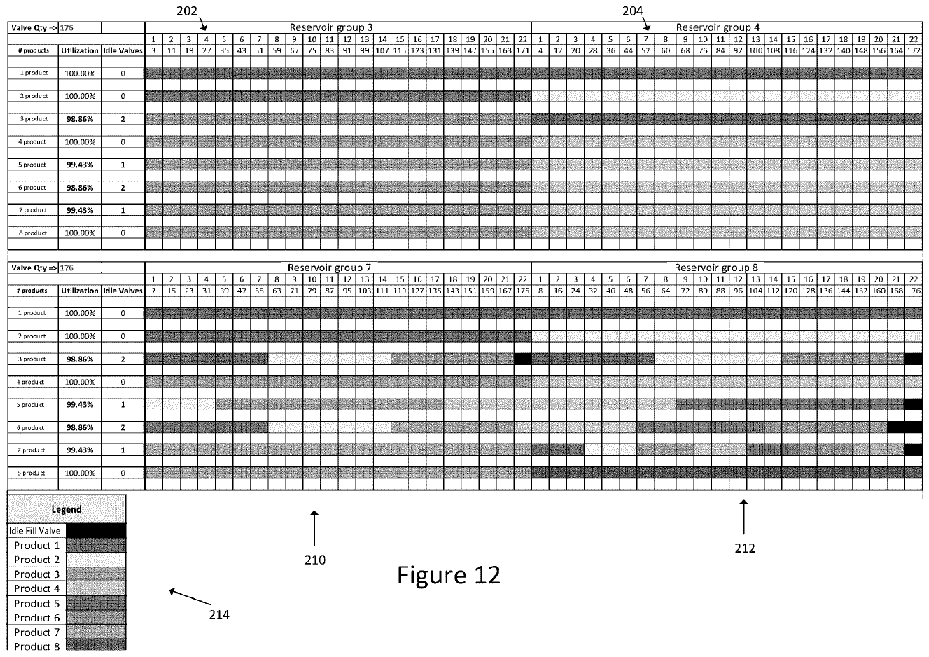

Turning to FIG. 10, a chart illustrating the mapping of the filler valves in the multi-product filler device 2 is provided, when the filler device 2 is used to dispense a given number of different products. FIGS. 11 and 12 are magnified views of the overall FIG. 10 arrangement. Stepping through the information presented in FIG. 10, in a first column 190 eight rows are provided to indicate the number of different products which are to be dispensed by the filler device 2 during a given filling operation. A first row 192 is indicative of a single product, or “flavour”, to be dispensed using the entire assets (all independent, mix-proof fluid channels) of the filler device 2. This translates to all of the independent, mix-proof fluid inlets, supply conduits, reservoirs and filling conduits etc. to all filler valves being used to dispense the same product. A second row 193 is indicative of two products to be dispensed, and so on for three, four, five, six, seven and eight products being dispensed for the duration of the associated production run. A row labelled 34, located in the top left hand region of FIG. 10, and showing the values 1, 9, 17 etc., indicates the filler valve, and associated branch, number in question. For example, at the row 34, column 196 indicates the number ‘1’, so that filler valve/branch corresponds to the first filler valve labelled 12 in FIG. 6 (e.g. filler valve/branch number 1). In the example of a maximum 8 product multi-product filler device comprising 176 filler valves, uppermost row 194 indicates the reservoir (/sector group) which valve 34 is in (default) fluid communication with. In the example max. 8 product, 176 valve embodiment, to maintain preferably continuous product supply and dispensing though the filler valves, the (default) valves and hence associated filling conduits forming the branches from each reservoir are equally distributed about the periphery of the filler carousel and being radial, the branches are hence also equally distributed about the associated reservoir from which the product to be dispensed is drawn. As there are 176 filler valves and 8 reservoirs, it computes that in the example embodiment, there will be 176/8=22 branches per reservoir. As such, the values in the row 194 of FIG. 10 increase up to a maximum of 22.

The map shown in FIG. 10 is also generally separated into eight reservoir groups as indicated by the labels 198, 200, 202, 204, 206, 208, 210, 212. Finally, each of the various markers provided in the FIG. 10 map indicate what product should be dispensed from that particular filler valve 34 for a given total number of products 190 being dispensed from the filler device 2 during that production run. For example, in instances where a single flavour is to be dispensed from the entire filler device 2 (i.e. row 192), all eight product inlets, supply conduits and reservoirs may be used and would handle the same product, which would in turn be dispensed through all branch (21 per reservoir) that every filler valve 34 is utilized and dispenses a first product, as indicated by legend 214. All the assets and hence 100% of the filler device installed production capacity is therefore utilized.

It is observed that for each of the first to fifth reservoir groups 198, 200, 202, 204, 206; irrespective of the number of different products 190 to be dispensed by the filler device 2 at any one time, all of the filler valves 34 in that reservoir group, dispense the same product. Given that each of the filler valves of a particular reservoir group are by default connected to a particular reservoir (e.g. all of the filler valves of the sixth reservoir group 208 are connected to at least the sixth reservoir, see also FIG. 6), as long as each of the filler valves 34 of a given reservoir group are to dispense the same product, the default reservoir can be filled with that product. Described another way, and taking the second reservoir group 200 as an example, even though the filler valves 34 of the second reservoir group 200 dispense either the first or second products depending on whether one flavour 192 or two flavours 193 are to be dispensed by the filler device 2, because all of the filler valves 34 of that reservoir group 200 dispense a common product, the multi-product reconfiguration of the filler device 2 can be achieved by simply filling the corresponding reservoir (e.g. the second reservoir) with the appropriate product, i.e. either the first or second products as required. With the above in mind, each of the filler valves of the first to fifth reservoir groups need only be connected to a single reservoir. This is desirable for the reason that comparatively complex valve arrangements can be avoided. Described another way, there is no need for particular filler valves 34 within the first to fifth reservoir groups to deliver different products different to that contained in the default reservoir to which they are simply connected to. Described another way, all filler valves within a given reservoir group dispense a uniformed, single product for filler valves in the first to fifth reservoir groups.

Turning to consider a different scenario to that described above, and considering the sixth reservoir group 208, when five different products are to be dispensed by the device 2 (as indicated by row 216), the filler valves 34 belonging to the sixth, seventh and eighth reservoir groups 208 to 212 dispense a selection of the first to fifth products that the very nearly the full installed filling capacity of the filler device 2 is still productively harnessed. The total number of filler valves distributed across the sixth to eighth reservoir groups 208 to 212 are divided by the number of products to be distributed (i.e. 5) and, rounded down to the nearest round number, that the remaining number of filler valves are utilized in equal proportion to dispense the five products being filled during this production run. In the illustrated arrangement this leaves a single idle filler valve 218 owing to the fact that 5 does not divide exactly into the total of 3×22=66 filler valves. Eleven filler valves from across the 66 total then dispense one of the first to fifth products, and in as evenly distributed manner as possible about the periphery of the filler device carousel. From across this range, and first considering filler valves in the sixth reservoir group 208, these filler valves dispense one of the first or second products. Filler valves of the 1^{st} to the 13^{th} sector groups 194 dispense the first product, whilst filler valves belonging to the 14^{th} to 22^{nd} sector groups 194 dispense the second product. Because the filler valves within a particular reservoir group are required to dispense different products, it is not possible to simply change the product which is held in that (default) reservoir. Instead, at least a subset of the filler valves are networked (i.e. connected to) multiple different reservoirs, so that they can be selectively placed in (preferably) mix-proof fluid communication with (one of) the multiple different reservoirs, to be able to dispense the necessary product. Given that the filler valves in the sixth reservoir group 208 are connected to the sixth reservoir by default, filler valves belonging to 1^{st} to the 13^{th} sector groups 194 are also therefore connected to the first reservoir (corresponding to the first product). The filler valves belonging to 14^{th} to 22^{nd} sector groups 194 are connected to the second reservoir (corresponding to the second product) as well as the sixth reservoir by default. This mapping is also illustrated in FIG. 6 whereby the sixth filler valve 84 is connected to the first and sixth reservoirs 6, 46 as indicated by nodes 98, 100.

Effectively, the mapping of filler valves to reservoirs according to the invention provides the filler device 2 with the functionality of being able to dispense up to eight different products, but also being able to dispense only a single product. This is being achieved while maintaining full or very nearly full (as described above) full filler device 2 filler valve asset utilization and hence filling capacity. Further, this is achieved whilst the filler device 2 outputs an equal number of filled containers of each different product without the need that each filler valve be connected to each individual reservoir (which would be both costly and complex). The invention therefore defines a very efficient mapping of filler valves to reservoirs to achieve a very flexible multi-product filler device, which regardless of however many products are simultaneously dispensed (between one and the maximum number the filler device is designed), may always operate at, or very nearly at, full design capacity.

Turning briefly to consider another example, attention is drawn to seventh filler valve 213 in the seventh reservoir group 210. From the column 213 it will be appreciated that, in instances where three, five or six products are to be dispensed, the seventh reservoir group 210 requires that the filler valves in this reservoir group be provided in fluid communication with different reservoirs, depending upon the sector group 194 in question, as opposed to all of the filler valves within the entire seventh reservoir group 210 dispensing a single product. Considering the seventh filler valve 213 specifically: i) where three products are to be dispensed the seventh filler valve 213 dispenses a first product; ii) where five products are to be dispensed the seventh filler valve 213 dispenses a second product; and iii) where six products are to be dispensed the seventh filler valve dispenses the first product. It therefore follows that the seventh filler valve 213 should be connected to the reservoirs corresponding to the first and second products, as well as the default seventh reservoir. It therefore follows that the seventh filler valve 213 is connected to each of the first, second and seventh reservoirs. Turning briefly to FIG. 7, and considering the seventh filler valve 86, it will be appreciated that the seventh filler valve 86 can be placed in fluid communication with any of the first reservoir 6, second reservoir 18 and seventh reservoir 48 via nodes 104, 106, 104 (indicative of mixed-proof valves) respectively. As mentioned above, in instances where an entire reservoir group is configured to dispense a single, uniform product (e.g. the sixth sector group 208 where four flavours are to be dispensed) the default reservoir can simply be filled with the product to be dispensed (e.g. the second product). Product received from a product inlet may be described as a product stream.

Two further columns shown in FIG. 10 but not yet described in detail yet are labelled 220, 222. Column 220 indicates the utilisation of filler valves across the reservoir groups when a given number of products are to be dispensed. Column 222 indicates the number of idle filler valves across all of the filler valves in total when a given number of products are to be dispensed. For example, where a single product is to be dispensed (e.g. row 192) all of the filler valves dispense the first product (e.g. 0 idle filler valves, so 100% filler device 2 utilisation). However, for instances where three products are to be dispensed, the 175^{th} and 176^{th} filler valves 223, 225 (in the seventh and eighth reservoir groups 210, 212 respectively) are idle. This is owing to the fact the total 176 filler valves is not visible by three (products) exactly. The utilisation 220 percentage is calculated by dividing the total number of active filler valves by the total number of filler valves.

Described another way, utilisation is equal to the total number of filler valves (e.g. 176 in the illustrated embodiment) minus the number of idle valves as indicated in column 222, divided by the total number of filler valves. As will be appreciated from column 220, the device 2 is enable to utilise almost 100% of filler valves irrespective of whether a single product, or a plurality of different products, is to be dispensed.

FIGS. 11 and 12 are identical to FIG. 10 other than for the fact that they show magnified views of only part of the map. FIG. 11 only shows first, second, fifth and sixth reservoir groups 198, 200, 206, 208, and FIG. 12 only shows third, fourth, seventh and eighth reservoir groups 202, 204, 210, 212. Legend 214 is also shown.

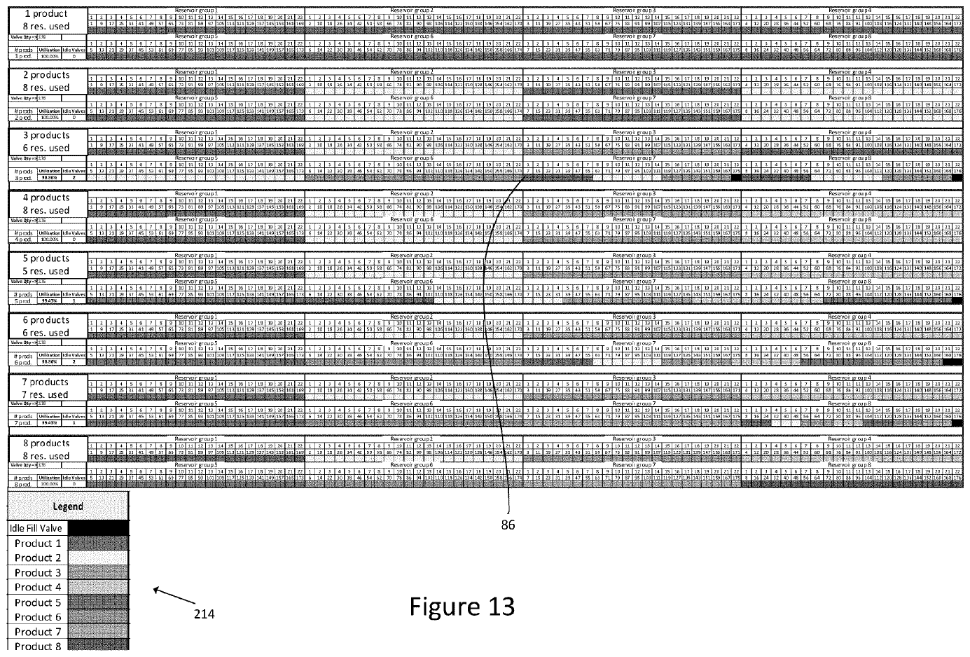

Turning to FIG. 13, the map shown in FIG. 10 is presented in a different format. In FIG. 13, rows are provided which relate to the number of different products dispensed by the filler device. FIG. 13 can be considered to be a collection of eight mini-maps, with each mini-map relating to a map for a given number of products to be dispensed. It will be appreciated that FIG. 9 is effectively the collation of the different mini-maps shown in FIG. 13. Of note, on the left-hand side of FIG. 13 a number of products to be dispensed and the number of reservoirs used is indicated. Beginning with comparatively straightforward scenarios, where a single product is to be dispensed each filler valve dispenses that single product. Each filler valve can therefore simply be connected to its default reservoir (e.g. first reservoir for the first reservoir group, second reservoir for the second reservoir group etc.) and each of the reservoirs be filled with the first product. Where two products are to be dispensed, all filler valves can again be used. In this instance, first, third, fifth and seventh reservoir groups dispense a first product, whilst the remaining valves of the other reservoir groups dispense the second product. This is similar to instances where four products are to be dispensed. In that instance, third and seventh reservoir group filler valves dispense a third product, whilst fourth and eighth reservoir groups dispense a fourth product. Again, all filler valves can be used with the relevant reservoirs being filled with the corresponding product to be dispensed.

Another scenario is that where eight products are to be dispensed. In this arrangement, again each of the filler valves can be used and each of the filler valves belonging to the relevant reservoir groups dispense a different product out from their default reservoir. For example, the first reservoir group filler valves dispense a first product from that (first) reservoir, whilst filler valves from the second reservoir group dispense the second product from that (second) reservoir.

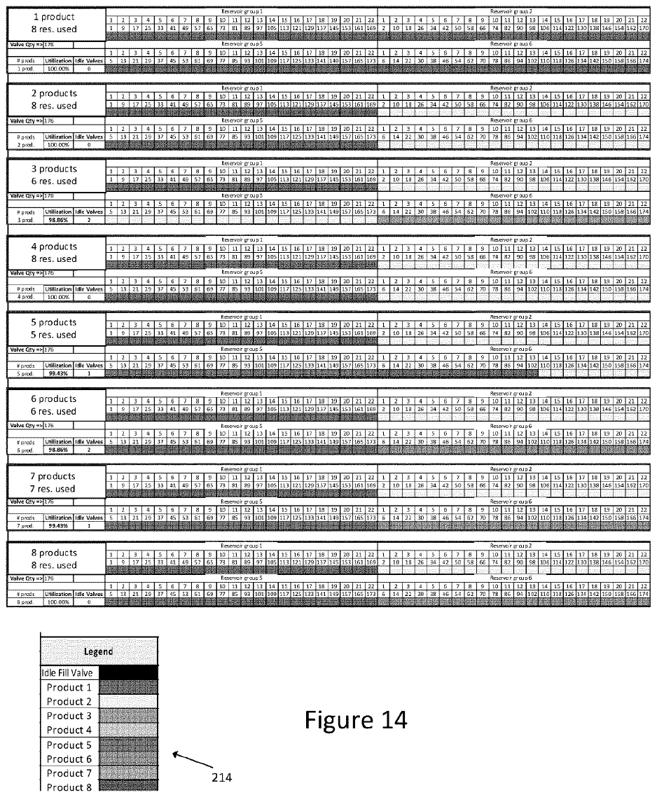

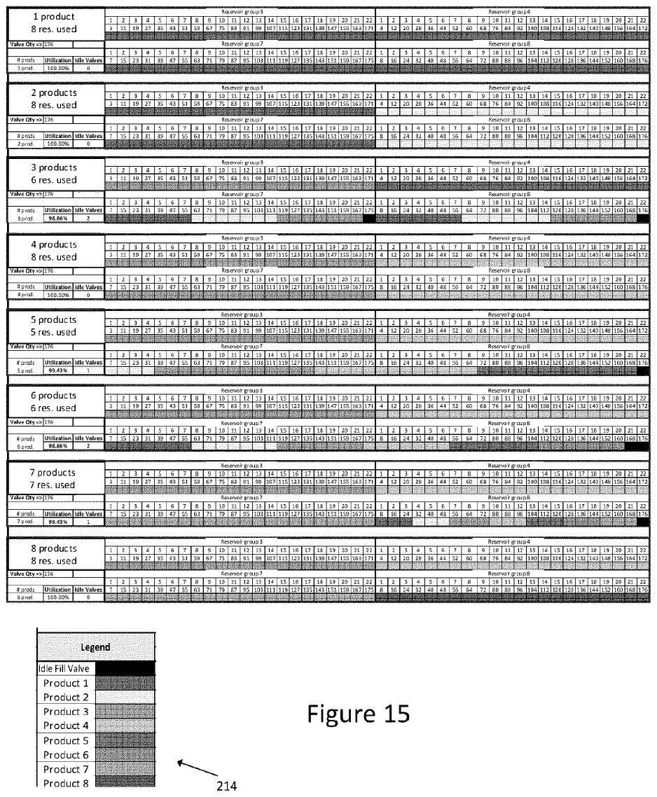

In scenarios where three products are to be dispensed, filler valves belonging to the first and fourth reservoir groups dispense a first product, filler valves belonging to the second and fifth reservoir groups dispense a second product and filler valves belonging to third and sixth reservoir groups dispense a third product. The filler valves belonging to the seventh and eighth reservoir groups are divided into three groups, with each of the groups dispensing one of the first, second and third products respectively. There are also two idle valves, one in each group. As such, the relevant filler valves of the seventh and eighth reservoir groups are connected so that they can be placed in selective fluid communication with the relevant reservoir as needed for the map. For example, the seventh filler valve 86 should be capable of being provided in fluid communication with a first reservoir, the default reservoir for the first product. A similar explanation to that provided above is also applicable to arrangements where 5 and 7 products are to be dispensed. Each of FIGS. 14 and 15 are simply magnified views of a portion of the reservoir group mapping shown in FIG. 13. That is to say, the combination of FIGS. 14 and 15 is identical to that shown in FIG. 13.

Turning to FIG. 16, a chart showing the utilisation of the reservoirs in the maps shown in FIGS. 10 to 15 is provided. A first column 224 indicates the number of different products to be dispensed by the multi-product filler device 2. Of note, a number of products to be dispensed does not increase from one to eight products in a sequential order in FIG. 16. A second (major) column 226 indicates the reservoir in question. Sub-columns numbered 1 to 8, within column 226, are representative of the first to eighth reservoirs respectively. Columns 220 and 222 indicate the filler utilisation and the number of idle filler valves as previously described. Legend 214 is also provided, which indicates the product in question, as well as a new final row 228 indicative of the reservoir not being used.

Each row of FIG. 16 corresponds to the number of products to be dispensed by the device 2. By comparing column 226 with the legend 214, FIG. 16 illustrates which product is provided in each reservoir, and if the reservoir is, or is not, in use. For example, considering a first row 230, indicative of a single product being dispensed by the device, the map indicates that each of the 1^{st} to 8^{th} reservoirs be filled with the first product. Of note, the hatched pattern in the 6^{th} to 8^{th} reservoir boxes indicates that the entire device could actually be serviced by only the 1^{st} to 5^{th} reservoirs where only a single product is dispensed. The use of the 6^{th} to 8^{th} reservoirs in this arrangement is therefore optional. FIG. 16 indicates how, for scenarios where 1, 2, 4 or 8 products are to be dispensed, the map split across the various reservoirs is relatively straightforward because the total of 8 reservoirs is readily visible by the 1, 2, 4 or 8 products to be dispensed. More complicated scenarios arises where 3, 5, 6 or 7 products are instead dispensed. For each of these ‘non-divisible’ scenarios, at least one of the reservoirs is not used as indicated by symbol 228. Where 5 products are to be dispensed, each of reservoirs 6, 7 and 8 is not used. This does not mean that the filler valves associated with these reservoirs are not used because, as described in connection with FIGS. 10 to 15, the filler valves associated with each of these groups can be placed in fluid communication with at least one other reservoir (which is used).

Turning to FIG. 17, a table showing a summary of the device 2 is provided. FIG. 17 indicates that in the example filler device 2, there are 176 filler valves in total, and that 111 filler valves are without mix-proof valves. The total 111 arises from the fact there are 22 filler valves in each of the first to fifth reservoir groups (i.e. 22×5=110 filler valves) which are only connected to one reservoir, and the 176^{th} filler valve is also only connected to a single reservoir (see FIG. 18, row 244 for the 176^{th} filler valve). FIG. 17 also indicates that the total number of filler valves which do require mix-proof valves (e.g. the total number of filler valves which are connected to at least two reservoirs) is 65. A total number of valves required is 184 (e.g. there are 184 connections of filler conduits to reservoirs where that filler conduit is connected to multiple reservoirs). Finally, FIG. 17 also shows the number of filler valves which have an associated 2, 3, 4 or 5 mix-proof valves connected to the respective filler conduit (e.g. a total number of filler valves which are connected to 2, 3, 4 or 5 reservoirs respectively).

Turning to FIG. 18, a magnified view of the example filler device 2 mapping of the filler valves for the sixth to eighth reservoir groups 208, 212 is provided. For completeness, the illustrated mapping of FIG. 18 corresponds to a selection of rows (e.g. number of products dispensed) 190 for the sixth to eighth reservoir groups 208, 212 of FIG. 9. Rows 194 and 34 correspond to a number 1-22 of the valve associated with a particular reservoir and which are connected about 360 degrees about that reservoir, and filler valve number 34 respectively. Rows 230, 232, 234, 236 indicate the maps for when three, five, six and seven products are dispensed respectively. Rows 238, 240 and 242 indicate the default reservoir connection for each filler valve in the respective 6^{th}, 7^{th} and 8^{th} reservoir groups. For example, for the 6^{th} reservoir group 208, the row 238 indicates the default connection is to the 6^{th} reservoir (containing the sixth product). The same row is empty for the 7^{th} reservoir group 210 because the row 238 corresponds to the 6^{th} reservoir group only. Row 244 indicates the number of mix-proof valves for the corresponding filler valve 34 (e.g. the number of different reservoirs that filler valve 34 needs to be able to be placed in selective fluid communication with in order to achieve the map). Taking the 6^{th} filler valve as an example, as well the default connection to the sixth reservoir, the valve also needs to be able to be placed in selective fluid communication with the first reservoir in order to dispense the first product. Two fluid connections are therefore required, with each having a corresponding (mix-proof) valve.

Turning finally to row 246, an indicating mapping per filler valve is provided. The ‘61’ indicated in the corresponding entry for the sixth filler valve is indicative of the sixth filler valve being capable of being placed in fluid communication with each of the sixth and first reservoirs. Of note, FIG. 18 only corresponds to filler valves where the entire reservoir group does not dispense a single variety of product. As previously explained, in instances where this is the case, that default reservoir for that reservoir group can be filled with the required product.

From row 244 it will be appreciated that each of the filler valves in the sixth, seventh and eighth reservoir groups 208, 210, 212 can be placed in selective fluid communication with 2, 3, 4 or, in two instances five, different reservoirs. This is other than for the 176^{th} filler valve which is indicated as an idle filler valve.

To summarise, each of FIGS. 6 to 18 described above relate to the product filler device 2 shown in FIG. 1 in which filler valves are connected to multiple reservoirs such that the filler valve can be selectively placed in fluid communication with one of those reservoirs. This provides the advantage that the filler device 2 can be reconfigured in use depending on how many different products need to be dispensed.

The Figures of 19 onwards relate to a further embodiment, corresponding to the devices 102, 102a shown in FIGS. 2, 3 and 4, in which at least a subset of the reservoirs are connected to multiple product inlets such that any one or more of the subset reservoirs can singularly or in pair or groups be selectively placed in fluid communication with one of the said product inlets. Described another way, in contrast to the preceding embodiments, whereby a filler valve is connected to multiple reservoirs in order to select from which one of those reservoirs the different product to be dispensed from a given filler valve, in the following embodiment each filler valve is connected only to a single reservoir, and it is the reservoir which is connected to different product inlets to be able to achieve a similar result (i.e. to be able to select which product is dispensed by the given filler valve). Stated as “similar”, as in the context of the overall machine, the objective is always to do so while maintaining full or very nearly full utilization of the filler device dispensing assets and hence filling capacity. As will be appreciated in the explanation below, there may be an acceptable trade off between capacity at a given number of products to be filled vs overall machine complexity. Whereas in the previous filler valve mapping (filler device 2), the flexibility while maintaining capacity was a function of product reservoir placement and then harnessing the feature of filler valve mapping to perform the final routing of the said products to the appropriate filler valves for balanced dispending of each product or flavour variant, in the following filler bowl mapping version of the filler device (filler device 102), the flexibility while maintaining capacity is a function of placing the appropriate product in the appropriate reservoir and/or which reservoir sector thereof, i.e. via greater granularity and hence choice of reservoir a near equal functional execution is realized at greatly reduced complexity. This stated, for optimum flexibility vs complexity a hybrid combination of the two embodiments may be realised, a filler device 2 execution of limited extent downstream of the filler reservoirs and segmented reservoirs, and a filler device 102 execution of same or limited extent upstream of the filler reservoirs and segmented reservoirs.

Turning to FIG. 19, a multi-product filler device 102 according to a second embodiment, corresponding to that shown in FIGS. 3 and 4, is provided. The device 102 shares many features in common with the device 2, and only the differences will therefore be described in detail. Similarly, many of the features of the map shown in FIG. 19 are common to the map shown in FIG. 6, and only the differences will be described in detail.

Like the device 2 shown in FIG. 6, the rotary filler device 102 takes the form of a carousel which is rotatable about an axis of rotation 32. Like the filler valve sequence 66 as labelled in FIG. 7, the circumferential arrangement of circles in FIG. 19 represents, in this embodiment 168 filler valves which make up the filler device 102. Each of the filler valves is identified by a filler valve number 34. These increase from 1 to 168 moving in a clockwise direction from the first filler valve 12. Like the map shown in FIG. 6, in FIG. 19 the concentric rings moving from the radially outer first reservoir 6 to the comparatively radially inner fifth reservoir 44 indicate separate annular reservoirs which may (preferably) be coplanar. The first to fifth reservoirs take the form of non-segmented annular bowls (vessels), each of which contains a given product. In contrast to the map shown in FIG. 6, the three radially innermost concentric rings 248, 250, 252 represent three filler bowls, each of which is segmented into three separate reservoirs. Each reservoir and/or reservoir sector is an individual, mix-proof product vessel, complete with liquid level and gas over pressure control. The reservoirs (and reservoir sectors) permit very stable operating conditions for the dispensing of precise quantities of product through each filler valve. The concentric rings indicate first, second and third segmented bowls 248, 250, 252 respectively (which may be referred to as sixth, seventh and eighth bowls). The bowls are segmented about the three dividing lines 254, 256, 258 which extend from the axis of rotation 352. Dividing lines 254, 256, 258 schematically split each of the first, second and third segmented bowls 248, 250, 252 respectively into three circumferential sectors, each representing mix-proof and full function enabled reservoir sectors 248a-c, 250a-c and 252a-c, respectively. These reservoir sectors extend around 120° of the segmented bowls 248, 250, 252 about the axis of rotation 32.

In the present example the three radially innermost bowls 248, 250, 252 are segmented. However, it is equally the case that any of the bowls could be segmented-it need not be the innermost. In some examples the outermost bowls may be segmented, this may be beneficial during certain product runs as the outermost bowls have the largest capacity. In other examples, any other combination (e.g. sequential, alternate, irregular) of bowls may be segmented.

By providing the first, second and third segmented bowls 248, 250, 252 with three reservoir sectors each, each bowl effectively provides three separate reservoirs which can each hold a same or different product independently, (i.e. such that each segmented bowl, comprising three reservoir sectors each, may contain up to three different products). The three segmented annular bowls 248, 250, 252 each comprises three reservoir sectors, (248a, 248b, 248c), (250a, 250b, 250c), (252a, 252b, 252c), respectively. As already mentioned, each reservoir, in the form a sector of the overall annular bowl, is a complete, mix-proof and independently supplied and controlled (e.g. product liquid level, CO₂ gas pressure) reservoir. As previously mentioned, a radially inner sequence of numbers 34 indicates the filler valve number (e.g. first filler valve 12 is identified). In the FIG. 6 illustration, the radially outer sequence of numbers is referred to as the reservoir group. For ease of description here in FIG. 19, the outermost group 260 is referred to as a bowl group. That is to say, the bowl group 260 indicates which bowl the filler valve in question is connected to. First to fifth bowls 6, 18, 40, 42, 44 correspond to first to fifth reservoirs 6, 18, 40, 42, 44, whereas the sixth to eighth bowls 248, 250, 252 correspond to the first to third segmented bowls, encompassing reservoir sectors (248a, 248b, 248c), (250a, 250b, 250c), (252a, 252b, 252c), respectively. For example, from FIG. 19 it will be appreciated that the first filler valve 12 is connected to the first reservoir 6, the second filler valve is connected to the second reservoir 18 and so on until the sequence is repeated for each of the maximum number of products the filler device 102 is designed for. In the example 8 product (max.), 168 filler valve embodiment the sequence repeats 168/8=21 times, thus as the sequence is repeated to distribute the radial filler branches about the periphery of the annular filler bowls, 21 filler conduits are connected to each annular reservoir (first to fifth) and 7 equi-spaced radial filler branches and associated filler conduits to each of the three reservoir sectors making up the sixth, seventh and eighth filler bowls, respectively, i.e. again totalling 21 filler branches per filler bowl. In the illustrated map each filler valve is only connected to a single reservoir. From the combination of the device 102 shown in FIG. 19, and the legend 214, it will be appreciated that each of the reservoirs (e.g. 7^{th} to 14^{th} reservoirs) making up the first, second and third segmented bowls 248, 250, 252 can be filled with a same or a different product. As previously mentioned, this provides an alternative solution to adjusting the product in the reservoir which is then dispensed through the connected set of filler valves.

Turning to FIG. 20, a cross section view of the multi-product filler device 102 shown in FIG. 19 is provided. FIG. 20 also schematically illustrates the mapping of various product inlets to the reservoirs and reservoir sectors, as will be described below. The cross section view of FIG. 20 corresponding to filler device 102, shows many features in common with the cross section view shown in FIG. 9, the FIG. 9 view corresponding to the filler device 2. As such, only the differences will be described in detail. Like the previous embodiment, in FIG. 20 the device 102a comprises first to fifth reservoirs 6, 14, 40, 42, 44, respectively. Each of the respective reservoirs contains a different product (at least in the illustrated embodiment). Each of these reservoirs also constitutes an annular bowl which extends around the axis of rotation 32 fully. Unlike the previous embodiment, the filler device 102 comprises first, second and third segmented bowls 248, 250 252, respectively. Each of these segmented bowls extends around the axis of rotation 32, but each consists of three separate reservoir sectors (e.g. 7^{th} to 14^{th} reservoirs). Each of the three separate reservoir sectors can contain a different product (but can equally contain the same product, where appropriate, or even, if unused, remain empty).

Each reservoir is serviced by an independent product supply provided via mix-proof channelling through the liquid supply hub 188 located along the axis of the rotary carousel (i.e. the axis common to the concentric annular bowls (reservoirs)). Each of the utility media and possibility of maximum eight different products streams (in this example of the embodiment) are ported to the rotational carousel of the filler device 102 from the mix-proof media supply hub 188. Each product port from the media supply hub 188 is referred to as the product inlet. Each of the eight product inlets (in this example embodiment) is discharged from the designated port 4, 16, 164, 166, 168, 170, 172, 174, respectively, and routed through to the designated reservoir or reservoir sector via the corresponding supply conduit. Each of the eight reservoirs tagged 6, 14, 40, 42, 44, 248, 250, 252, respectively, has one default product supply each. As the sixth 248, seventh 250 and eighth 252 reservoirs (filler bowls) comprise three reservoir sectors each, the default product supplies to the sixth, seventh and eighth reservoirs branch out to three supply conduits, serving one reservoir sector each. Each of the branches from the primary supply conduit connected to the product inlet (at the hub) is executed via a (preferably) mix-proof valve, that when not selected for use after rinsing and/or detergent CIP (clean in place) washing, that product supply conduit remains CO₂ pressurised and empty for the duration of the following production run. Each supply conduit is equipped with a flow control valve to regulate the flow for constant fill level within each reservoir or reservoir sector. The CO₂ gas over pressure of each reservoir or reservoir sector may be independently pressure controlled by a dedicated CO₂ pressure control valve per reservoir.

In the filler device 102 embodiment, alternate product dispensing to filler valves for always balance primary container (e.g. Cans or Bottles) per product supply stream into the filler device 102, is achieved by having a selection of filler valve connected product reservoir sectors in which to supply alternate, different from default liquid, products to. Like the execution of default product supplies to the segmented filler bowls being connected to via mix-proof valves and branched out to e.g. three product deliveries, one to each of the three reservoir sectors, likewise to realise the product mapping to always achieve full, or near full, filler device capacity utilization, some primary product supply conduits, including those to filler bowls six, seven and eight, may be further branched out via mix-proof valves to supply other reservoirs and/or reservoir sectors. A reservoir or reservoir sector may therefore have more than one product supply conduit connection, but always only one shall be used per production run and for the full duration of the production run, before being rinse and/or CIP cleaned ahead of any reconfiguration for the following production run.

In the FIG. 20 example of the embodiment, the execution is per FIG. 2, the preferred execution, with the product supply routing valves connected to and thus mounted off the supply conduits and the product deliveries being made direct into the destination reservoirs or reservoir sectors via individual nozzles not shared with any other (different) product supply. The mix-proof and flow control valves are therefore positioned within the rotary carousel portion of the filler device 102. As described earlier, other executions, with some influence on the channelling and hence complexity of the mix-proof product and media supply hub 188, may realise some or all of the hygienic process valves (single seat, mix-proof, modulating), located off the rotary carousel, at a stationary installation close to the filler device 102. It must be noted that the filler conduits shown coming out the bottoms of each reservoir are not interconnected, but are shown behind one another. Each filler valve is connected to only one reservoir or reservoir sector, as shown in FIG. 19.

The left hand side of the filler device 102 shown in FIG. 20 is illustrative of the 161^{st} branch 262 (which comprises the 161^{st} filler valve 266), as shown in FIG. 19, whilst the right hand side is illustrative of the 77^{th} branch 264 (which comprises the 77^{th} filler valve 268). When considering FIG. 20 in combination with the legend 214, it will be appreciated that the 161^{st} filler valve 266 is only connected to the first reservoir 6 (which contains the first product). It will also be appreciated that, at the illustrated circumferential position, the 1^{st}, 2^{nd} and 3^{rd} segmented bowls 248, 250, 252 provide 8^{th}, 11^{th} and 14^{th} reservoirs 248c, 250c, 252c. This is in contrast to the reservoirs provided at the 77^{th} branch 264, which, for the first, second and third segmented bowls 248, 250, 252 are the 7^{th}, 10^{th} and 13^{th} reservoirs 248b, 250b, 252b respectively.

The present example provides great flexibility and efficiency in terms of product delivery, with relatively low complexity. Namely, the example includes only sixteen mix-proof networking valves—6 associated with the primary product supply to the default bowls and 10 associated with the networking of the segmented bowls. Similarly, there are only twenty-four flow control valves—fourteen associated with the primary product supply to the default bowls and ten associated with the networking of the segmented bowls.

The various reservoirs which make up the segmented bowls 248, 250, 252 are provided in selective fluid communication with various product inlets as needed via respective supply conduits (e.g. at least 14, one for each reservoir, in this embodiment). In the illustrated embodiment, at least a subset of the individual reservoirs which make up the segmented bowls 248, 250, 252 may be connected to a plurality of supply conduits, one supply conduit for each product ‘combination’ to be supplied to that reservoir. For example, if the reservoir is to be in fluid communication with the first and second product inlets, such that either of the first and second products can be contained within that reservoir, that reservoir may be connected to each of the first and second product inlets via respective supply conduits (e.g. a total of two supply conduits). This corresponds to the arrangement shown in FIG. 2, or 4. Alternatively, each reservoir may be associated, or connected to, only a single supply conduit, but that supply conduit branch, or fork, to connect to a plurality of different product inlets (e.g. like that shown in FIG. 3).

Each of the first, second and third to eighth product inlets 4, 16, 164, 166, 168, 170, 172, 174 are also shown in FIG. 20. Like FIG. 9, the product inlets form part of a (preferably) mix-proof utility media and product supply column (hub) 188. Valves, which may be mix-proof valves, are used to selectively place the segmented bowl reservoirs in fluid communication with one of multiple product inlets as needed (e.g. to supply the reservoir with different products, depending upon the fluid connection). The first product inlet 4 is also connected to multiple segmented reservoirs by respective supply conduits 282, 284, 286, each via a respective (preferably) mix-proof valves 288, 290, 292. Each of the supply conduits to each of the segmented reservoirs may thus be effectively isolated from the main supply conduit being from which product supply is being drawing, via the said (preferably) mix-proof valve associated with it. Each supply conduit to each of the segmented reservoirs is equipped with a flow regulation valve to in turn manage the product level in the reservoir or segmented reservoir, being served. Any of the reservoirs connected to the first product inlet 4 can therefore be placed in fluid communication with the first product inlet 4, and so contain and dispense the first product to filler valves in fluid communication with those reservoirs.

Turning to FIG. 21, a summary table, like that shown in FIG. 16, is provided in connection with the filler device 102a. A first column 190 indicates the number of products to be dispensed by the filler device 102a. A second column 220 indicates the utilisation of filler valves for that number of products to be dispensed. Row 270 indicates the annular bowl number, from 1 to 8, that the reservoir belongs to. Row 272 indicates the reservoir number, within the annular bowl number 270, in question. As such, each of 1^{st} to 5^{th} annular bowls consist of a single (1^{st} to 5^{th}) reservoir. Each of the 6^{th}, 7^{th} and 8^{th} bowls correspond to the first, second and third segmented annular bowls and each consist of three separate reservoirs (e.g. the 6^{th} bowl consists of the 6^{th} to 8^{th} reservoirs etc.). In instances where between one and eight products are to be dispensed, other than four, five and seven product scenarios, each of the reservoirs is configured to contain a particular product and the filler valve utilisation is therefore 100%. Only in scenarios where there are five or seven products are to be dispensed does the utilisation reduce from 100% to 83% or 88% respectively. This is owing to the fact that if the non-used reservoirs were filled with product, such that the associated filler valves dispense said product, there would be an uneven distribution of product across the total number of filler valves (e.g. for five products, the four non-used reservoirs could dispense first to fourth products respectively, but the overall device would be lacking a group of filler valves to dispense a corresponding fifth product). This would lead to an uneven output of filled containers, for packing into multipacks.

The utilisation column 220 value is calculated by dividing the number of filler valves used, for a given number of products to be dispensed, by the total number of filler valves (e.g. 168 in this embodiment). Taking the scenario where seven products are to be dispensed, only one of the eight reservoirs is not used, so 7/8 reservoirs are used (and so an associated 7/8 total filler valves are used). 7/8 utilisation, expressed as a decimal, is 0.875, which rounds to 88% as indicated in the table.

FIG. 22 is a schematic illustration showing the mapping of reservoirs of a different embodiment of device 102b to product inlets. FIG. 21 illustrates how a subset of reservoirs (particularly circumferential sector reservoirs) may be connected to a plurality of supply conduits (e.g. supply conduits 294-298 which are each connected to circumferential sector reservoir 300).

For completeness, the description provided in connection with FIG. 8A, re. each filler valve preferably being connected to a single filler conduit, is also applicable to the embodiments shown in FIGS. 19 to 22.

As well as the embodiments previously described, it will also be appreciated that a combination of the two embodiments may be employed. That is to say, to further improve flexibility, at least a subset of the filler valves may be capable of being selectively placed in fluid communication with more than one reservoir whilst at least a subset of the reservoirs may be capable of being selectively placed in fluid communication with more than one product inlet. The devices shown in the preceding figures, as well as any optional and/or preferred features disclosed in connection therewith, may therefore be combined as a single device (e.g. as shown in FIG. 5).

1. A multi-product filler device comprising:
a first product inlet for supplying a product to the device;
a first reservoir configured to contain a volume of product;
a first supply conduit connected to the first product inlet and the first reservoir and configured to supply product to the first reservoir;
a first filler valve configured to dispense product into a first container;
a first filler conduit connected to the first reservoir and the first filler valve for delivering product from the first reservoir to the first filler valve;
a second product inlet for supplying a product to the device;
a second reservoir configured to contain a volume of product;
a second supply conduit connected to the second product inlet and the second reservoir and configured to supply product to the second reservoir;
a second filler valve configured to dispense product into a second container
a second fluid filler conduit connected to the second reservoir and the second filler valve for delivering product from the second reservoir to the second filler valve.

2. The device of claim 1, wherein:
the first reservoir is additionally connected to the second product inlet such that the first reservoir can be selectively placed in fluid communication with either of the first product inlet and the second product inlet; and/or
the first filler valve is additionally connected to the second reservoir such that the first filler valve can be selectively placed in fluid communication with either of the first reservoir and the second reservoir

3. The device of claim 2, wherein:
the first reservoir is further connected to the second supply conduit, by means of a mix-proof valve, for supplying product from the second product inlet to the first reservoir; and/or
the first filler conduit is connected to the first and second reservoirs, and the first filler conduit comprises a mix-proof valve associated with each of the first and second reservoirs.

4. The device of claim 1, wherein the multi-product filler device is a rotary multi-product filler device and the reservoirs are annular bowls or sectors thereof.

5. The device of claim 1, wherein the multi-product filler device comprises eight product inlets, including the first and second product inlets, for supplying products to the device.

6. The device of claim 1, wherein the multi-product filler device comprises eight reservoirs, including the first and second reservoirs.

7. The device of claim 1, wherein the device is a multi-beverage filler device for use as part of a filling plant.

8. The device of claim 2, wherein the first supply conduit is in fluid communication with two or more, and optionally up to all, of the product inlets such that the first reservoir may be selectively placed in fluid communication with any of the two or more, and optionally up to all, of the product inlets.

9. The device of claim 2, comprising:
a plurality of product inlets for supplying a product to the device, including the first and second product inlets;
a plurality of reservoirs, including the first and second reservoirs, configured to contain a volume of product;
a plurality of supply conduits, including the first and second supply conduits, each supply conduit being connected to at least one of the product inlets and a respective one of the reservoirs and configured to supply product to the respective reservoir; wherein
each of a subset of the reservoirs is connected to one, two or more than two (e.g. three, four, five, six or up to all) of the product inlets such that the respective reservoirs can be selectively placed in fluid communication with any of the one, two or more of the product inlets.

10. The device of claim 1, wherein the first reservoir is a circumferential sector of a segmented annular bowl.

11. The device of claim 10 comprising fourteen reservoirs including the first and second reservoirs, wherein:
five of the reservoirs are annular bowls;
nine of the reservoirs are sectors of segmented annular bowls, the nine sectors collectively forming three further annular bowls; and
the first reservoir is one of the sectors of a segmented annular bowl; optionally wherein
the device further comprises:
eight product inlets for supplying a product to the device, including the first and second product inlets; wherein
each of the nine sector reservoirs may be connected to one, two or more (e.g. three, four, five, six or up to all) of the product inlets such that the associated reservoirs can be selectively placed in fluid communication with any of the one, two or more (up to all) of the product inlets.

12. The device of claim 2, wherein the multi-product filler device comprises eight reservoirs, including the first and second reservoirs, and the first filler conduit is connected to one, two or more (e.g. three, four or five, up to all) of the reservoirs such that the first filler valve can be selectively placed in fluid communication with any of the respective reservoirs.

13. The device of claim 2, comprising:
a plurality of reservoirs, including the first and second reservoirs, each reservoir being configured to contain a volume of product;
a plurality of filler valves, including the first and second filler valves, each filler valve being configured to dispense product into a container;
a plurality of filler conduits, including the first and second filler conduits, each filler conduit being connected to an associated filler valve and at least one of the reservoirs, for delivering product from the at least one of the reservoirs to the associated filler valve; wherein
each of the filler conduits associated with a subset of the filler valves is in mix-proof fluid communication with one, two or more (up to all) of the reservoirs such that the associated filler valve can be selectively placed in fluid communication with any of the one, two or more (up to all) reservoirs; optionally
wherein at least half of the filler conduits are connected to only a single reservoir such that the associated filler valve can be in fluid communication with only a single reservoir.

14. The device of claim 13, further comprising:
a plurality of product inlets for supplying a product to the device, including the first and second product inlets;
a plurality of filler valves associated with each reservoir;
wherein
a plurality of the filler conduits are connected to only a single reservoir such that the corresponding filler valves can only be in fluid communication with the single associated reservoir;
a plurality of the filler conduits are connected to a plurality of reservoirs such that the corresponding filler valves can be placed in fluid communication with a plurality of reservoirs, including the associated reservoir.

15. The device according to claim 1, further comprising:
a third product inlet for supplying a product to the device;
a third reservoir configured to contain a volume of product;
a third supply conduit connected to the third product inlet and the third reservoir and configured to supply product to the third reservoir;
a third filler valve configured to dispense product into a third container;
a third filler conduit connected to the third reservoir and the third filler valve for delivering product from the third reservoir to the third filler valve;
a fourth product inlet for supplying a product to the device;
a fourth reservoir configured to contain a volume of product;
a fourth supply conduit connected to the fourth product inlet and the fourth reservoir and configured to supply product to the fourth reservoir;
a fourth filler valve configured to dispense product into a fourth container
a fourth fluid filler conduit connected to the fourth reservoir and the fourth filler valve for delivering product from the second reservoir to the second filler valve.

16. The device according to claim 15, wherein at least one of the first to fourth reservoirs is additionally connected to a further product inlet such that the at least one of the first to fourth reservoirs can be selectively placed in fluid communication with either of the respective first to fourth product inlets and the further product inlet; and/or
at least one of the first to fourth filler valves is additionally connected to a further reservoir of the first to fourth reservoirs such that the at least one of the first to fourth filler valves can be selectively placed in fluid communication with either of the respective first to fourth reservoirs and the further reservoir.

17. The device according to claim 15, wherein at least one of the first to fourth reservoirs is only connectable to a single product inlet; and/or
at least one of the first to fourth filler valves is only connectable to a single product inlet.

18. A method of operating the multi-product filler device according to claim 1, the method comprising:
placing the first filler valve in fluid communication with the first product inlet;
commencing a first filling operation;
dispensing the first product into the first container using the first filler valve;
finishing the first filling operation;
reconfiguring the multi-product filler device to place the first filler valve in fluid communication with the second product inlet;
starting a second filling operation; and
dispensing the second product into a further container using the first filler valve.
